(19) United States
(12) Patent Application Publication
(10) Pub. No.: US 2019/0005028 A1
(43) Pub. Date: Jan. 3, 2019

(54) SYSTEMS, METHODS, AND COMPUTER-READABLE MEDIUM FOR VALIDATION OF IDIOMATIC EXPRESSIONS

(71) Applicant: Rishi Mago, Newtown, PA (US)

(72) Inventor: Rishi Mago, Newtown, PA (US)

(21) Appl. No.: 16/120,303

(22) Filed: Sep. 2, 2018

(51) Int. Cl. G06F 17/27; G06F 17/30

(52) U.S. Cl. CPC G06F 17/2785; G06F 17/30684; G06F 17/271

(57) ABSTRACT

A method for validation of idiomatic expressions may include the steps of receiving an input text string; performing a search of a database based on the input text string, in which the database stores a plurality of idiomatic expressions; identifying a first set of idiomatic expressions, in which the first set includes at least one of the plurality of idiomatic expressions stored in the database, in which each idiomatic expression in the first set has an associated concordance score that meets or exceeds a predetermined concordance threshold value, in which the associated concordance score indicates a degree of similarity between the respective idiomatic expression in the first set and the input text string; and outputting the first set of idiomatic expressions. A computing device configured to implement the method and a non-transitory computer-readable medium configured to store instructions that define the method are also disclosed.

### BACKGROUND

### Technical Field

The present disclosure relates generally to systems, methods, and computer-readable medium for facilitating the review of text and the correction of errors therein. More particularly, the present disclosure relates to systems, methods, and computer-readable medium for validation of idiomatic expressions.

### Description of the Related Art

At its core, language is a tool for communication. While most organisms engage in some form of communication, human language is capable of communicating complex ideas, concepts, and feelings. The development of human language was arguably one of the most important steps in the evolution of humanity and in the development of modern civilizations. Language differs from other forms of communication in its systematic and formalized use of sounds and symbols. The formalization of written communication required the development of a complex set of rules that dictate how symbols (e.g., letters) are organized to form words that convey ideas. Generally, such rules of written communication include the spelling, punctuation, capitalization, etc. Formal rules about how such words are organized to form more complex ideas are generally referred to as grammar. Grammar is important because small variations in how words are organized, or even the placement of punctuation marks, can dramatically alter the meaning conveyed. Formal grammar is the codification of rules that developed from the repeated usage of particular words and language over a long period of time. In other words, grammar reflects what has been accepted as being correct for a particular language, and thus grammar adds some certainty as to meaning intended to be conveyed.

When studying a new language, students learn the rules that dictate how the language is spoken and written. Unfortunately, most languages are complicated and include words and groupings of words (i.e., phrases) that have a meaning which differs from their literal meaning and which sometimes also violates the normally accepted grammatical rules. That is to say, some words and phrases have a specialized meaning (i.e., a “figurative meaning”) that differs from what would be understood from the literal or conventional meanings of their words. Moreover, those phrases having a figurative meaning may also have a syntax that, while unconventional in other contexts, is in fact the correct syntax for that particular figurative phrase. For instance, an “idiom” is a phrase that has a culturally understood figurative meaning and/or usage, which generally would not be apparent or readily deducible from its individual constituent words (i.e., the words that comprise the idiom. In other words, an idiom is a phrase that generally has a figurative meaning which differs from the literal meaning conveyed by its constituent words.

As used herein, the term “idiomatic expression” includes any word or phrase that has an accepted figurative meaning including, but not limited to: idioms, figures of speech, expressions, metaphors, proverbs, similes, metonymies, synecdoches, oxymorons adynata, and the like. An idiomatic expression has a meaning that generally would not be apparent or readily deducible from the literal or conventionally accepted meaning of its constituent words. Rather, the meaning of the idiomatic expression is ascertained upon recognition of that particular idiomatic expression. A further discussion of idioms and other types of expressions can be found in the following publication by Ray S. Jackendoff in “The Architecture of the Language Faculty,” The MIT Press, 1997, the contents of which are hereby incorporated by reference herein in its entirety.

By way of example, the idiomatic expression “raining cats and dogs” (an idiom) would be understood by an English speaker with a high level of proficiency to have the figurative meaning “raining heavily,” rather than the literal meaning that cats and dogs are actually falling or descending like rain from the sky. Despite the word “raining” in this idiomatic expression being similar to its figurative meaning which concerns raining, a high level of proficiency in the language is still need to understand this expression. Other idiomatic expressions have special culturally understood meanings that may require an extremely high level of proficiency in the language (e.g., native proficiency) to understand. For example, the idiomatic expression “when pigs fly” (an adynaton) has the figurative meaning that something being discussed or referred to is impossible, just as pigs literally flying is impossible. However, a variation of this idiomatic expression that would also be literally impossible, such as “when horses fly,” would not convey the same figurative meaning as the original idiomatic expression (“when pigs fly”), because this variation involving “horses” has not been culturally accepted into the language as an idiomatic expression and thus it would not convey the same special culturally understood meaning.

As can be imagined, idiomatic expressions present a particularly difficult challenge for people without native proficiency in a language (e.g., a foreign speaker for whom the language is their second or third). Moreover, it is estimated that the English language has at least twenty-five thousand idiomatic expressions. Such idiomatic expressions also present a significant challenge for conventional computer systems, for example when attempting to detect errors in a text (e.g., proof-checking), since many figurative phrases are only understandable to a human with native proficiency in the language. It is therefore not surprising that conventional computer-automated attempts to detect grammatical errors in a text typically focus on those grammatical aspects of a language that have a more clearly defined sets of rules governing their usage, such as for example, contractions and verb conjugations.

Since idiomatic expressions need not follow the clearly defined grammatical rules of a language, conventional computer-automated attempts to detect grammatical errors in a text that contains idiomatic expressions may result in: (a) the computer system mistakenly recognizing a grammatical error that does not exist due to the presence of a correct idiomatic expression; and/or (b) the computer system failing to recognize an error made within the idiomatic expression itself due to the incorrect idiomatic expression containing otherwise correct grammar. Such errors made within the idiomatic expression may include, for example, errors in phrasing such as errors in word choice and errors in word order. As an example of (a) above, in situations where the defined conventional grammatical rules conflict with a correct idiomatic expression included in the text, the conventional computer-automated attempt to detect errors may mistakenly recognize the correct idiomatic expression as being a grammatical error because it does not comply with the defined conventional grammatical rules. As an example of (b) above, in situations where an incorrect idiomatic expression included in the text contains an error in phrasing (e.g., an incorrect word choice such as “when horses fly” instead of the correct idiomatic expression “when pigs fly”), the conventional computer-automated attempt to detect errors may be unable to recognize this error made within the idiomatic expression itself (i.e., detect an incorrect idiomatic expression), because this type of error does not violate a defined conventional grammatical rule.

As the examples above illustrate, conventional computer systems that check for errors in text are currently far too limited so as to properly identify, analyze, and address idiomatic expressions contained within the text. The use of computer-automated methods to check spelling have become widespread in various applications such as word processors (e.g., Microsoft Word®) and online email services (e.g., Gmail®). While these conventional methods are generally effective to identify spelling errors, they are quite limited in capability and are unable to check for the correctness of an idiomatic expression (e.g., phrased correctly or used correctly). More recently, the use of computer-automated methods to check grammar have emerged (e.g., the software product Grammarly®), however these methods are presently unable to check for the correctness of an idiomatic expression as well. The lack of conventional computer-automated means to check for the correctness of idiomatic expressions in a text may require a human to expend a significant amount of time and effort in order to attempt to determine the correctness of what the human presumes to be idiomatic expressions.

Such a determination regarding presumed idiomatic expressions in a text requires a human to at least ascertain whether there has been an error in phrasing (such as an incorrect word choice in the idiomatic expression) and/or an error in use or application (due to a misunderstanding of the idiomatic expression's figurative meaning). The human may attempt to manually and actively look up each presumed idiomatic expression in a dictionary, on an individual basis, in order to ascertain its proper phrasing and its figurative meaning, which would entail an extraordinary amount of time and effort by the human. This labor-intensive manual process lacks both time efficiency and effectiveness, as discussed further below, and therefore such an approach is not practical when employed in real-world applications.

A substantial problem with this manual approach is that it requires the human to already suspect that the presumed idiomatic expression may contain an error, otherwise the human is unlikely to expend the significant time and effort involved. This is a crucial flaw on the part of the manual approach, since the human many not even suspect there has been an error. In an alternative form of the manual approach, the human may use an online search engine instead of a traditional dictionary. However, this does not cure one of the manual approach's crucial flaws, because this manual approach still requires the human to already suspect that the presumed idiomatic expression may contain an error. Therefore, the manual approach is entirely ineffective unless the human already suspects that an error may have occurred.

In an attempt to mitigate the failures due to this crucial flaw, the human may use the manual approach on each and every presumed idiomatic expression contained within a text (instead of only those suspected to contain an error), however this is simply not practical in terms of time or effort when examining (e.g., proof-checking) a text of any significant length. In addition, another problem with the manual approach is that certain phrasing errors (e.g., word choice) will cause the manual approach to fail such that the correct idiomatic expression that was intended will not be found. For example, if the error in word choice regards the first word in the presumed idiomatic expression (i.e., an incorrect first word was used), then the manual approach may fail because the human may be unable to find the correct idiomatic expression in the dictionary. In another example, if the error in word choice is considerable (e.g., the majority of the words in the idiomatic expression have been incorrectly chosen), then even an online search engine may not be able to suggest the correct idiomatic expression that was intended due to not having been provided with enough useful correct input. Therefore, the manual approach may be ineffective for some incorrect idiomatic expressions containing errors in phrasing regardless of whether a dictionary or an online search engine is utilized.

It can therefore be appreciated that the manual approach may not be practical for a human to perform in terms of efficiency (e.g., the time and effort involved) nor very useful in terms of the results it provides (i.e., not sufficiently effective). Accordingly, the conventional means for proof-checking a text for errors related to idiomatic expressions (i.e., the validation of idiomatic expressions), including the manual approach and the conventional computer-automated methods, are insufficient to accomplish this undertaking. Thus, there is a continuing need for new methods and systems that automate the labor-intensive process of validating idiomatic expressions and which improve upon the efficiency and the effectiveness as compared to the conventional means.

Accordingly, there is a need for systems, methods, and computer-readable medium that facilitate the validation of idiomatic expressions. The foregoing discussion is provided to facilitate a better understanding of the present disclosure and technical field to which it pertains, and is not to be regarded as any admission of prior art.

### SUMMARY

In accordance with aspects of the present disclosure, a computing device that is configured to perform validation of idiomatic expressions may include one or more processors and a memory storing computer-readable instructions that, when executed by the one or more processors, cause the computing device to: (a) receive an input text string; (b) perform a search of a database based on the input text string, in which the database stores a plurality of idiomatic expressions; (c) identify a first set of idiomatic expressions, in which the first set includes at least one of the plurality of idiomatic expressions stored in the database, in which each idiomatic expression in the first set has an associated concordance score that meets or exceeds a predetermined concordance threshold value, in which the associated concordance score indicates a degree of similarity between the respective idiomatic expression in the first set and the input text string; and/or (d) output the first set of idiomatic expressions. The associated concordance used by the computing device score may be determined based on a comparison between the respective idiomatic expression in the first set and the input text string, in which the comparison may be performed by utilizing a string distance function and/or an n-gram based technique.

In accordance with aspects of the present disclosure, a method for validation of idiomatic expressions may include the steps of: (a) receiving an input text string; (b) performing a search of a database based on the input text string, in which the database stores a plurality of idiomatic expressions; (c) identifying a first set of idiomatic expressions, in which the first set includes at least one of the plurality of idiomatic expressions stored in the database, each idiomatic expression in the first set has an associated concordance score that meets or exceeds a predetermined concordance threshold value, in which the associated concordance score indicates a degree of similarity between the respective idiomatic expression in the first set and the input text string; and (d) outputting the first set of idiomatic expressions. The associated concordance score used by the method may be determined based on a comparison between the respective idiomatic expression in the first set and the input text string, in which the comparison may be performed by utilizing a string distance function and/or an n-gram based technique.

In accordance with aspects of the present disclosure, a non-transitory computer-readable medium may be configured to store instructions that when executed cause a processor to perform validation of idiomatic expressions, the processor being further configured to: (a) receive an input text string; (b) perform a search of a database based on the input text string, in which the database stores a plurality of idiomatic expressions; (c) identify a first set of idiomatic expressions, in which the first set includes at least one of the plurality of idiomatic expressions stored in the database, in which each idiomatic expression in the first set has an associated concordance score that meets or exceeds a predetermined concordance threshold value, in which the associated concordance score indicates a degree of similarity between the respective idiomatic expression in the first set and the input text string; and (d) output the first set of idiomatic expressions. The associated concordance score may be determined based on a comparison between the respective idiomatic expression in the first set and the input text string, in which the comparison may be performed by utilizing a string distance function and/or an n-gram based technique.

The above and other aspects, features, and advantages of the present disclosure will become apparent from the following description read in conjunction with the accompanying drawings, in which like reference numerals designate the same elements.

### BRIEF DESCRIPTION OF THE DRAWINGS

A further understanding of the present disclosure can be obtained by reference to preferred embodiments set forth in the illustrations of the accompanying figures. The illustrated preferred embodiments are merely exemplary of methods, structures, and compositions for carrying out the present disclosure. Both the organization and method of the disclosure, in general, together with further objectives and advantages thereof, may be more easily understood by reference to the figures and the following description. The figures are not intended to limit the scope of this disclosure, which is set forth with particularity in the claims as appended or as subsequently amended, but merely to clarify and exemplify the disclosure.

For a more complete understanding of the present disclosure, reference is now made to the following figures in which:

FIG. 1 is a schematic block diagram depicting an embodiment of a computing device, according to aspects of the disclosure;

FIG. 2 is a diagram depicting an embodiment of a database table, according to aspects of the disclosure;

FIG. 3 is a diagram depicting an embodiment of a database table, according to aspects of the disclosure;

FIG. 4A is a diagram depicting an embodiment of a database table, according to aspects of the disclosure;

FIG. 4B is a block diagram depicting an embodiment of the database table associated with FIG. 4A, according to aspects of the disclosure;

FIG. 5 is a flowchart depicting an embodiment of a process performed by a computing device, according to aspects of the disclosure;

FIG. 6 is a flowchart depicting an embodiment of a subprocess associated with FIG. 5, according to aspects of the disclosure; and

FIG. 7 is an illustration depicting an embodiment of a user interface for a computing device, according to aspects of the disclosure; and

FIG. 8 is an illustration depicting an embodiment of a user interface for a computing device, according to aspects of the disclosure.

### DETAILED DESCRIPTION

Reference will now be made in detail to embodiments of the invention that are illustrated in the accompanying figures. Wherever possible, the same or similar reference numerals (which may be in numerical or alphanumerical format) are used in the figures and the written description to refer to the same or like parts or steps. The figures are in simplified form and are not to precise scale. The figures are non-limiting examples of the disclosed embodiments of the present disclosure and corresponding parts or steps in the different figures may be interchanged and interrelated to the extent such interrelationship is described or inherent from the disclosures contained herein. The specific functional and structural details disclosed herein are merely representative, yet in that regard, they are deemed to afford the best embodiment for purposes of disclosure and to provide a basis for the claims herein, which define the scope of the present disclosure.

As will be discussed in greater detail hereinbelow, the present disclosure generally relates to systems, methods, and a non-transitory computer-readable medium for proof-checking a text, and more specifically for providing a validation of idiomatic expressions within the text. Systems for validation of idiomatic expressions may include devices that are specifically purposed to perform operations in accordance with the methods as presently disclosed. The devices may communicate with one another and may provide data as needed to perform the operations of the presently disclosed methods. A computing device for implementing the presently disclosed methods and a non-transitory computer-readable medium configured to store instructions that define the methods are also disclosed. In an aspect of the present disclosure, the systems, devices, methods, and non-transitory computer-readable medium provide users with validation of idiomatic expressions in a manner that may improve upon the efficiency and/or the effectiveness as compared to the conventional means.

The process for validation of idiomatic expressions as presently disclosed herein (i.e., the “validation process”) may provide a number of features and advantages that improve over the conventional art with respect to proof-checking a text for errors given at least the limitations of the conventional art with respect to identifying certain types of errors, particularly those types of errors that pertain to idiomatic expressions. The validation process may be performed upon an input text string and may provide a means to identify potential idiomatic expressions contained within the input text string. It should be understood that the term “input text string” generally refers to the text to be validated (i.e., proof-checked) for errors that pertain to idiomatic expressions by the validation process. In other words, the input text string may be validated by the systems, devices, methods, and non-transitory computer-readable medium described herein.

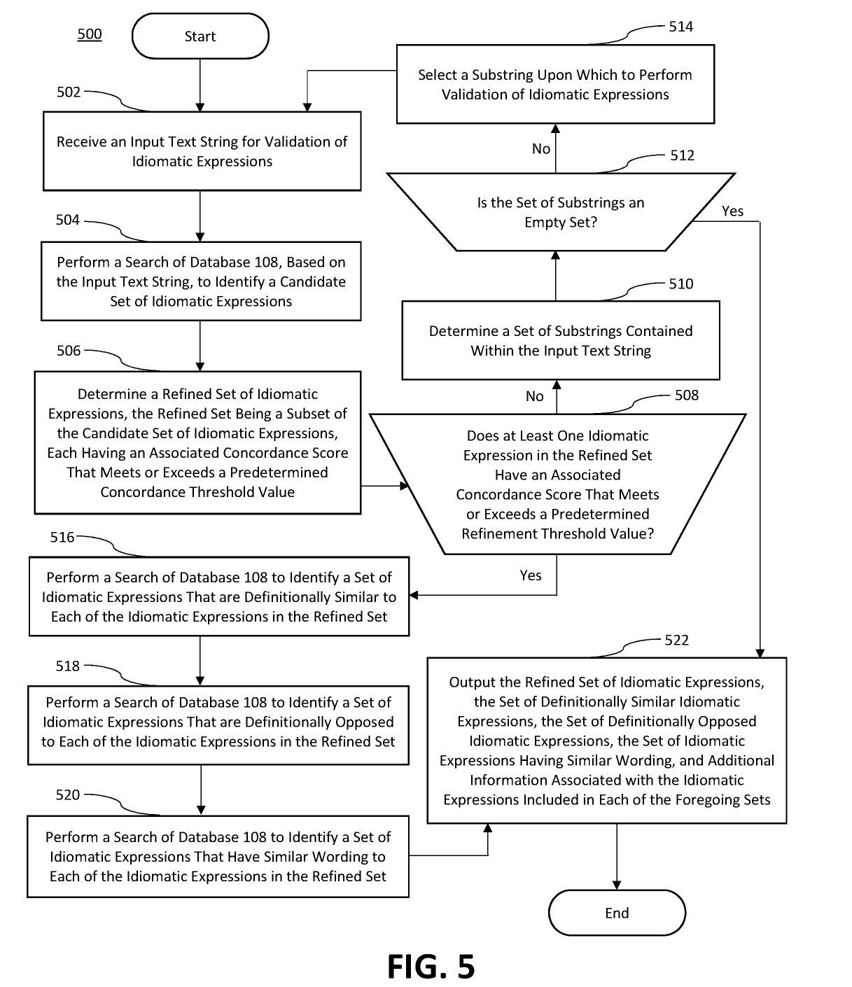

As discussed in detail below with reference to FIG. 5 and in particular operation 502, the input text string may be a string comprised of a sequence of characters that may represent, for example, a word, a phrase, a sentence, a paragraph, or any grammatical unit of language. The input text string may be identified automatically by any suitable means or identified by an action of a user (e.g., selection of the string in a larger text, inputting the string into an input text field such as a query box, etc.). A potential idiomatic expression contained within the input text string may be identified by the validation process as being a correct idiomatic expression or an incorrect idiomatic expression. Whether a potential idiomatic expression is identified as correct or incorrect may be determined by the validation process and attributable due to spelling, incorrect phrasing (e.g., word choice, word order), and/or any other aspects of the idiomatic expression that is examined by the validation process.

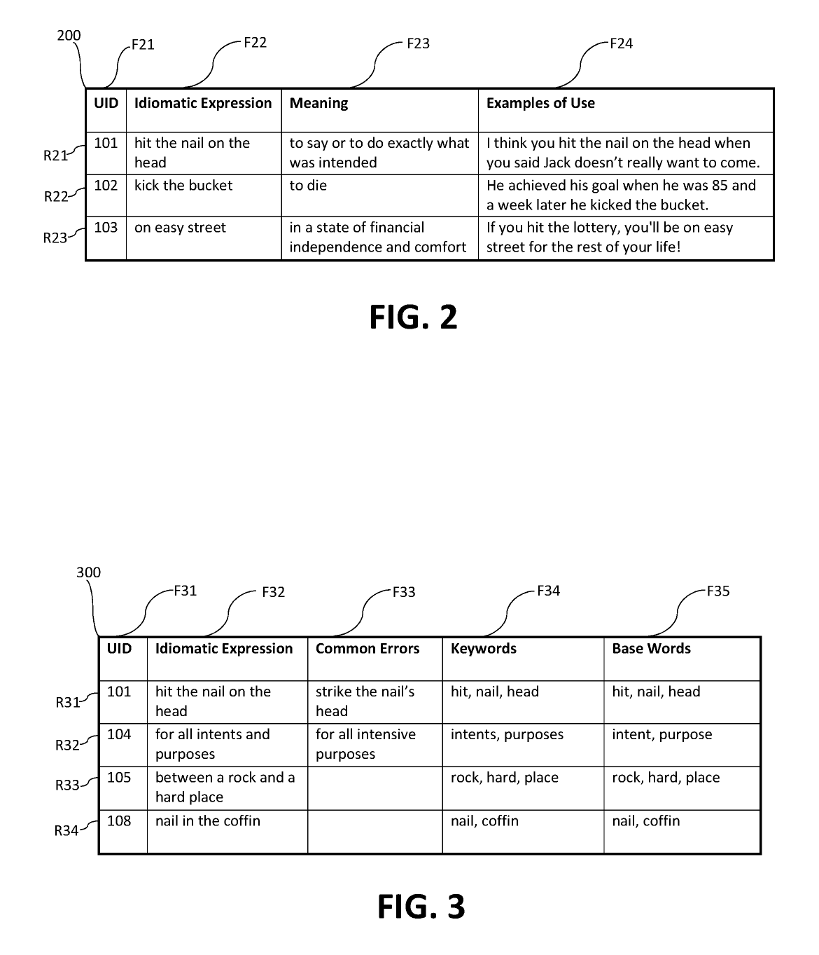

The validation process may provide an “explanatory description” associated with a particular idiomatic expression that has been identified by, or is being output by, the validation process. Such an explanatory description may contain various types of information associated with the particular idiomatic expression, as discussed in greater detail below with reference to FIG. 2. For instance, the explanatory description may include: (a) the meaning of the particular idiomatic expression; (b) examples of use associated with the particular idiomatic expression; and/or (c) additional information associated with the particular idiomatic expression.

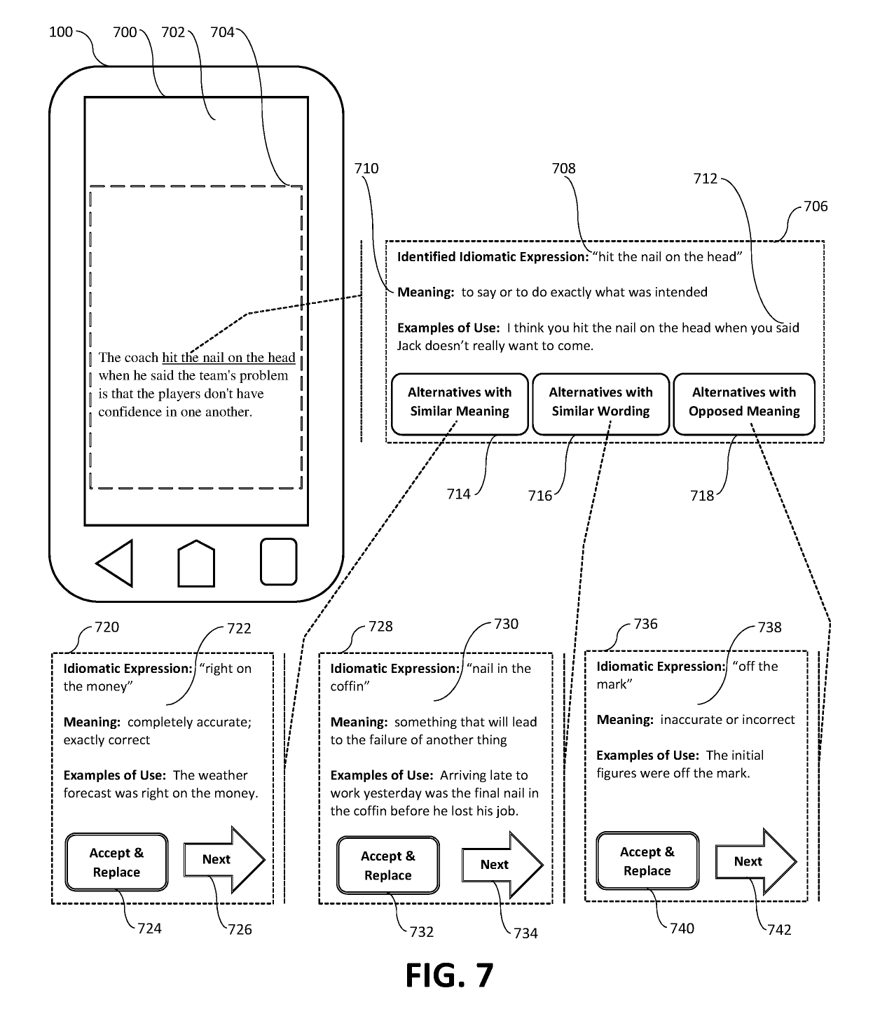

When the validation process identifies a correct idiomatic expression within the input text string, it may output an identified correct idiomatic expression (and its associated explanatory description). For example, a user of an application employing the validation process may be presented with the identified correct idiomatic expression and its associated explanatory description (or a portion thereof). Advantageously, the explanatory description may be of great value to the user, by enabling the user to confirm their understanding of the idiomatic expression's meaning, and further empowering the user to check whether their use of the idiomatic expression was correct in the context of the input text string based upon examples of use provided by the explanatory description. As exemplified by the user interface in FIG. 7 discussed further below, a user may be presented with a pop-up window 706, which displays the meaning and an example of use (i.e., the explanatory description or a portion thereof) associated with the identified correct idiomatic expression “hit the nail on the head.” Such information, i.e., the meaning and an example of use associated with the idiomatic expression, may be of great value to a user, and particularly so when the user does not have native proficiency in the language (e.g., a foreign speaker for whom the language is their second or third).

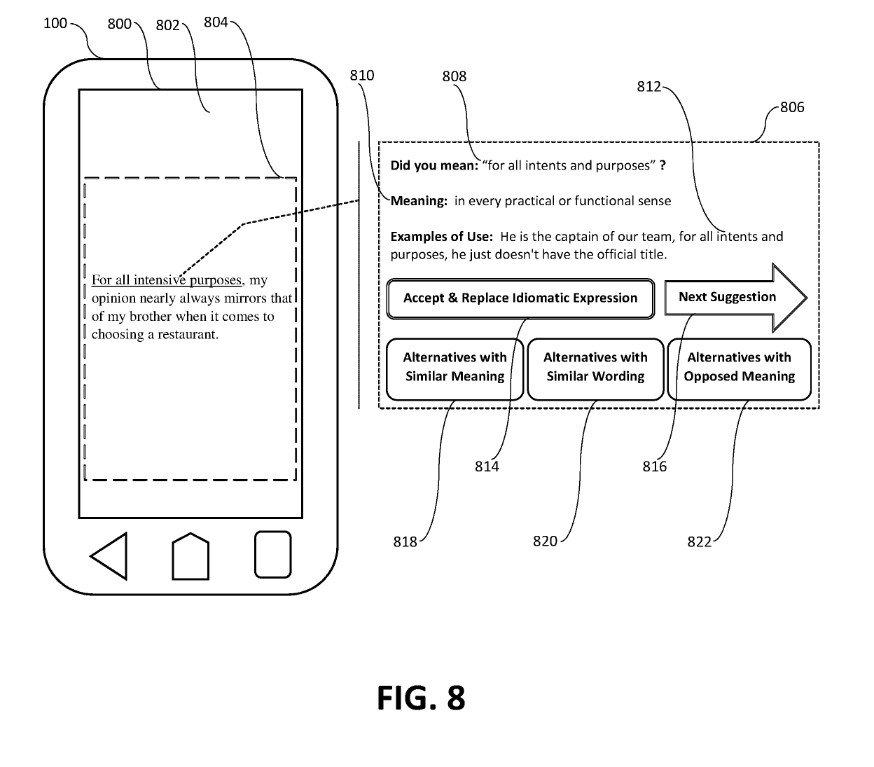

When the validation process identifies an incorrect idiomatic expression within the input text string, it may output a suggested correct idiomatic expression (and its associated explanatory description) that the validation process has determined to be a correct idiomatic expression that may have been intended to be used instead of the identified incorrect idiomatic expression (contained within the input text string). For example, a user of an application employing the validation process may be presented with a suggested correct idiomatic expression and its associated explanatory description (or a portion thereof). As exemplified by the user interface in FIG. 8 discussed further below, a user may be presented with a pop-up window 806, which displays the suggested correct idiomatic expression “for all intents and purposes,” its meaning, and an example of use associated therewith. Advantageously, viewing the suggested correct idiomatic expression may enable the user to immediately recognize certain types of errors made in the identified incorrect idiomatic expression (e.g., errors in phrasing such as word choice and word order). Further, the provided meaning and example of use may be of great value to the user, by enabling the user to further determine whether the suggested correct idiomatic expression would be correctly used in the context of the input text string in place of the identified incorrect idiomatic expression.

The validation process may output a set of suggested correct idiomatic expressions in some cases, rather than only one suggested correct idiomatic expression. The set of suggested correct idiomatic expressions may each be ranked and sorted by what is referred to herein as a “concordance score,” in which a concordance score may be associated with each suggested correct idiomatic expression. As used herein, the phrase “concordance score” may be understood as an indication as to the likelihood (e.g., statistical probability) of the suggested correct idiomatic expression associated with the concordance score being the correct idiomatic expression that was intended to be used instead of the identified incorrect idiomatic expression (contained within the input text string). Further, as discussed below with reference to FIG. 5 and in particular operation 506, in some embodiments the concordance score may indicate this likelihood as a degree of similarity between the suggested correct idiomatic expression and the identified incorrect idiomatic expression. Therefore, the set of suggested correct idiomatic expressions may each be ranked and sorted by their individual likelihoods of being the correct idiomatic expressions that was intended to be used instead of the identified incorrect idiomatic expression (contained within the input text string).

The validation process may additionally output various related idiomatic expressions in some embodiments. In some cases, such related idiomatic expressions may be associated with an identified correct idiomatic expression. In other cases, such related idiomatic expressions may be associated with a suggested correct idiomatic expression (as discussed above) that concerns an identified incorrect idiomatic expression. For instance, a user of an application employing the validation process may be presented with related idiomatic expressions including, for example: idiomatic expressions determined to have generally similar meanings to the identified correct idiomatic expression or the suggested correct idiomatic expression (i.e., definitionally similar idiomatic expressions); idiomatic expressions determined to have generally opposing meanings to the identified correct idiomatic expression or the suggested correct idiomatic expression (i.e., definitionally opposed idiomatic expressions), and/or idiomatic expressions determined to contain similar words to the identified correct idiomatic expression or the suggested correct idiomatic expression (i.e., idiomatic expressions containing similar wording).

Advantageously, the related idiomatic expressions provided by the validation process may be of great value to the user. The related idiomatic expressions may provide the user with a deeper understanding of the relevant idiomatic expression that was identified by the validation process, as discerned through the relevant idiomatic expression's connection to such related idiomatic expressions. Further, the related idiomatic expressions may provide the user with alternative idiomatic expressions that may be selected for use in place of, or in addition to, the idiomatic expression that was identified by the validation process. Thus, the validation process may improve the user's ability to select an idiomatic expression that is best suited to convey the meaning intended to be expressed in the context of the input text string. This is particularly valuable when the user does not have native proficiency in the language (e.g., a foreign speaker for whom the language is their second or third) and choosing which idiomatic expression to use in a particular context is a difficult task.

The present disclosure is not limited to any specific implementation or embodiment. Further, the methods disclosed herein can be implemented in software, in hardware, or in any combination of software and hardware. In some embodiments, the methods disclosed herein may be implemented as, for example: a part of a standalone program or web-based application (e.g., a local word processor, an online email client, etc.); a plugin (e.g., add-on, extension, etc.) for an existing program (e.g., a web browser, a word processor, a messaging application, etc.); a plugin for an existing web-based application (e.g., an online email service, an online search engine, etc.); a part of an application programming interface (API) that provides the validation process described above for a third-party computer program or web-based application; and/or any combination thereof. These exemplary implementations as well as other suitable means to implement the methods disclosed will be apparent to those of ordinary skill in the art.

In view of the foregoing discussion, a specific tool for validation of idiomatic expressions is provided by the systems, devices, methods, and non-transitory computer-readable medium as disclosed herein, in which the specific tool includes many advantages over the conventional art that ultimately result in significant value and benefits being provided to a user of the specific tool, as discussed in greater detail throughout the disclosure below. These and other aspects of the present disclosure are more fully discussed below with reference to the accompanying figures.

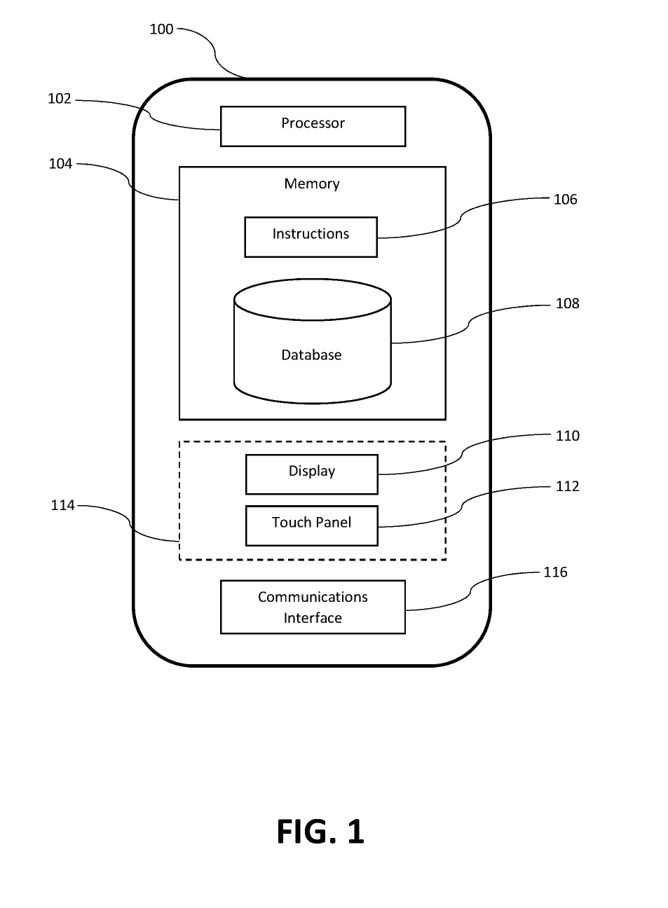

With reference to FIG. 1, a schematic block diagram is depicted of an embodiment of a computing device 100, according to aspects of the disclosure. In some embodiments, the computing device 100 may be implemented as a system of operatively connected computing devices and/or components. According to aspects of the disclosure, the computing device 100 may include any suitable type of computing device (including components thereof and programs executed thereon) that is capable of directly or indirectly executing instructions 106 and directly or indirectly communicating with database 108. For example, the computing device 100 may include one or more of a server, a server system (e.g., a load-balanced server farm, a geographically distributed server system), a desktop computer, a laptop computer, a tablet computer, a smartphone, a smart consumer electronics device, the like, and/or any combination thereof.

As illustrated in the depicted embodiment, the computing device 100 may include a processor 102, a memory 104, a communications interface, a display 110, and a touch panel 112. According to aspects of the disclosure, the processor 102 may include any suitable type of processing circuitry, such as a general-purpose processor (e.g., an ARM-based processor), an application-specific integrated circuit (ASIC), and a Field-Programmable Gate Array (FPGA). The memory 104 may include any suitable type of volatile and/or non-volatile memory capable of storing information that is accessible, directly or indirectly, by the processor 102, such as random-access memory (RAM), read-only memory (ROM), a hard disk (HD), a solid state drive (SSD), a flash memory, an optical disc storage (e.g, DVD, CD-ROM), network accessible storage (NAS), and online cloud storage (including related cloud computing web services).

The memory 104 stores information accessible by the processor 102, including instructions 106 that may be executed by the processor 102. The instructions 106 may be any set of instructions to be executed directly (such as machine code) or indirectly (such as scripts) by the processor. In that regard, the terms “instructions,” “steps,” “programs,” and “applications” may be used interchangeably herein. The instructions 106 may be stored in object code format for direct processing by the processor 102, or in any other computer language including scripts or collections of independent source code modules that are interpreted on demand or compiled in advance. The instructions 106 may include functions, methods, routines, the like, and/or any combination thereof.

The memory 104 stores a database 108 that is accessible by the processor 102. Database 108 stores information that may be accessed and/or manipulated by the processor 102. According to aspects of the disclosure, database 108 may include any suitable type of database, such as a relational database (e.g., Oracle database, IBM DB2, Microsoft SQL Server, MySQL, and PostgreSQL), a non-relational database (e.g, Neo4j, Redis, Apache Cassandra, Couchbase Server), a network database, a hierarchical database, an object-oriented database, a proprietary form of database, and various combinations and configurations of the foregoing.

According to aspects of the disclosure, database 108 stores information associated with idiomatic expressions. In some embodiments, at least some of the information stored on database 108 may be stored directly on the computing device 100 or stored externally on an independent computing device (not illustrated) such as, for example, a server or server system. The computing device 100 may directly or indirectly communicate with the independent computing device by means of the communications interface 116. The communications interface 116 operatively connects the computing device 100 and the independent computing device over any suitable type of network including one or more of the Internet, an intranet, a virtual private network (VNP), a wide area networks (WAN), a local area network (LAN), a telecommunications network (e.g., Long-Term Evolution (LTE), 4G, 3G), a private network using communication protocols proprietary to one or more companies, and various combinations and configurations of the foregoing. The communications interface 116 may include any suitable type of communications interface, such as a WiFi interface (e.g., utilizing IEEE 802.11 standards), an Ethernet interface, a wireless telecommunications interface (e.g., an interface for LTE, 4G, 3G, GSM, and/or CDMA, etc.), an Infrared interface, a Bluetooth Interface, a near field communication (NFC) interface, the like, and/or any combination thereof.

Although FIG. 1 functionally illustrates the processor 102 and the memory 104 as being within the same block, it will be understood by those of ordinary skill in the art that the processor 102 and the memory 104 may actually comprise multiple processors and multiple memories that may or may not be stored within the same physical housing. Further, some or all of the instructions 106 may be stored in a location physically remote from, yet still accessible by, the processor 102. For example, some of the instructions 106 may be stored within a read-only computer memory chip and others on removable flash memory or a network accessible storage (NAS). Similarly, the processor 102 may include a collection of processors that may or may not operate in parallel or that may or may not be part of the same cloud computing system.

The display 110 of computing device 100 may include any suitable type of display such as a liquid crystal display (LCD), a light-emitting diode (LED) display, or an active-matrix organic light-emitting diode (AMOLED) display. The touch panel 112 may include any suitable type of touch panel, such as a capacitive touch panel or a resistive touch panel. In some embodiments, the touch panel 112 may be layered onto the display 110 to form a touchscreen 114. Although not illustrated, the computing device 100 may additionally or alternatively include other input devices or components, such as a microphone, a keyboard, and a mouse. Although not illustrated, the computing device 100 may additionally or alternatively include other output devices, such as a visual output device or component (e.g., an external display), an audible output device or component (e.g., a speaker), a tactile output devices or component (e.g., a digital or electronic braille device, a haptic feedback component that makes use of the sense of touch by applying force, motions, or vibrations), and/or any other suitable output device or component that is configured to provide information in a format that is understandable to a user. An input device or output device utilized by the computing device 100 may be included as part of the computing device 100 itself or may be separate from the computing device 100 (e.g., as a standalone device, as part of another distinct device) while capable of communication, directly or indirectly, with the computing device.

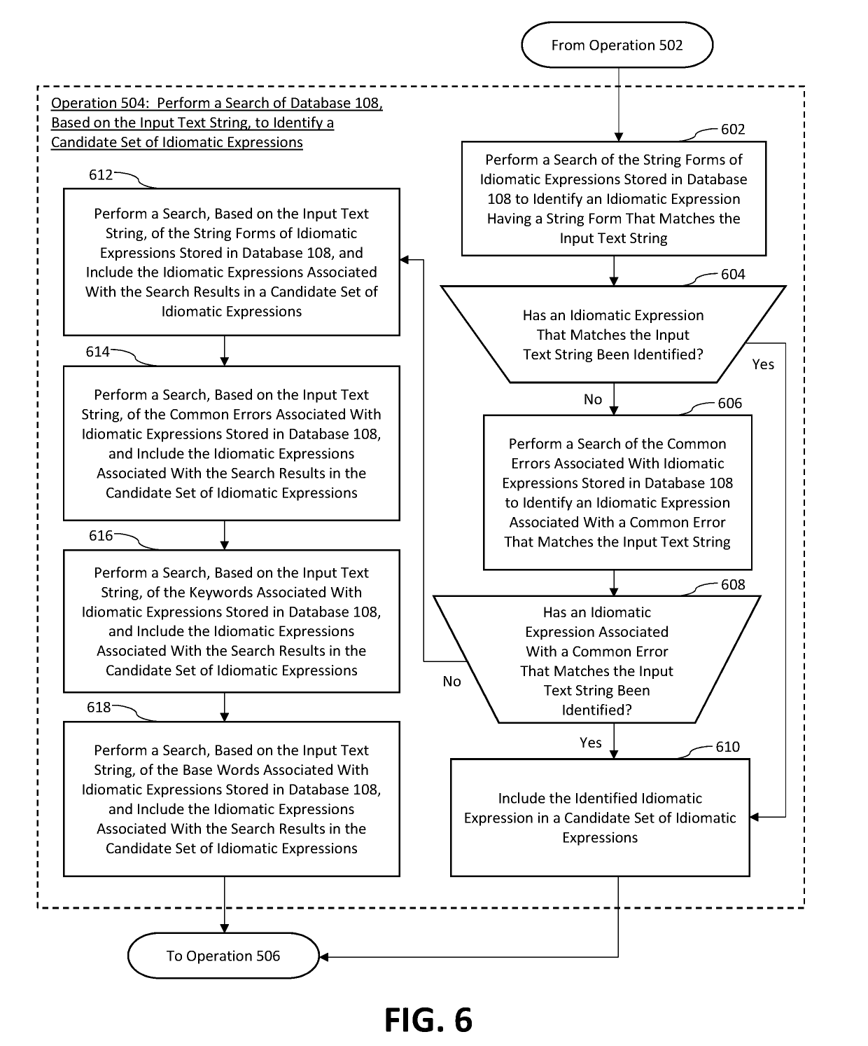

FIGS. 2-4B include diagrams depicting database tables according to various embodiments of the present disclosure. In some embodiments, the database tables of FIGS. 2-4B may be implemented as separate individual database tables (as shown). In some embodiments, the database tables of FIGS. 2-4B may be implemented as one master database table (not shown), in which the master database table includes all of the database fields contained within the database tables of FIGS. 2-4B. It will be apparent to those of ordinary skill in the art that either of these implementations (one master database table or separate individual database tables) may be used in accordance with the present disclosure, including utilization by the processes depicted in the flowcharts of FIGS. 5-6.

In some embodiments, the database tables of FIGS. 2-4B may joined together so as to operate in a manner that is capable of accomplishing the same functions as one master database table. As would be understood by a person of ordinary skill in the art, the database tables of FIGS. 2-4B may joined together through the use of any suitable key that defines the relationship between the database tables. A suitable key is one that is capable of linking the database records between one or more of the database tables of FIGS. 2-4B. As discussed below with reference to FIGS. 2-4B, each of the database tables 200, 300, and 400 may contain a database field that stores a unique identifier (“UID”) associated with each database record in the respective database table. For example, the database record containing the UID “101” in database table 200 links to the database record containing the UID “101” in database table 300 and the database record containing the UID “101” in database table 400, wherein each of these database records are associated with the same idiomatic expression “hit the nail on the head” in their respective database table.

In another embodiment, where the database tables of FIGS. 2-4B are implemented as one master database table, the master database table may contain a database field that stores a unique identifier (“UID”) associated with each database record in the master database table. A database record in the master table containing a particular UID (e.g., a UID of “101”) may contain all of the data stored in the database fields of database tables 200, 300, and 400 that are associated with database records containing the same UID (e.g., a UID of “101”) in their respective database table. For example, a database record in the master database table containing the UID “101” will be associated with the idiomatic expression “hit the nail on the head,” and that database record may also include database fields that store:

(i) the string form of the idiomatic expression “hit the nail on the head,” such as is stored in database field F22 of database table 200 described in detail below with reference to FIG. 2;

(ii) the meaning “to say or to do exactly what was intended” associated with the idiomatic expression, such as is stored in database field F23 of database table 200 described in detail below with reference to FIG. 2;

(iii) the example of use “I think you hit the nail on the head when you said Jack doesn't really want to come.” associated with the idiomatic expression, such as is stored in database field F24 of database table 200 described in detail below with reference to FIG. 2;

(iv) the common error “strike the nail's head” associated with the idiomatic expression, such as is stored in database field F33 of database table 300 described in detail below with reference to FIG. 3;

(v) the keywords “hit,” “nail,” and “head” that are associated with the idiomatic expression, such as are stored in database field F34 of database table 300 described in detail below with reference to FIG. 3;

(vi) the base words “hit,” “nail,” and “head” that are associated with the idiomatic expression, such as are stored in database field F35 of database table 300 described in detail below with reference to FIG. 3;

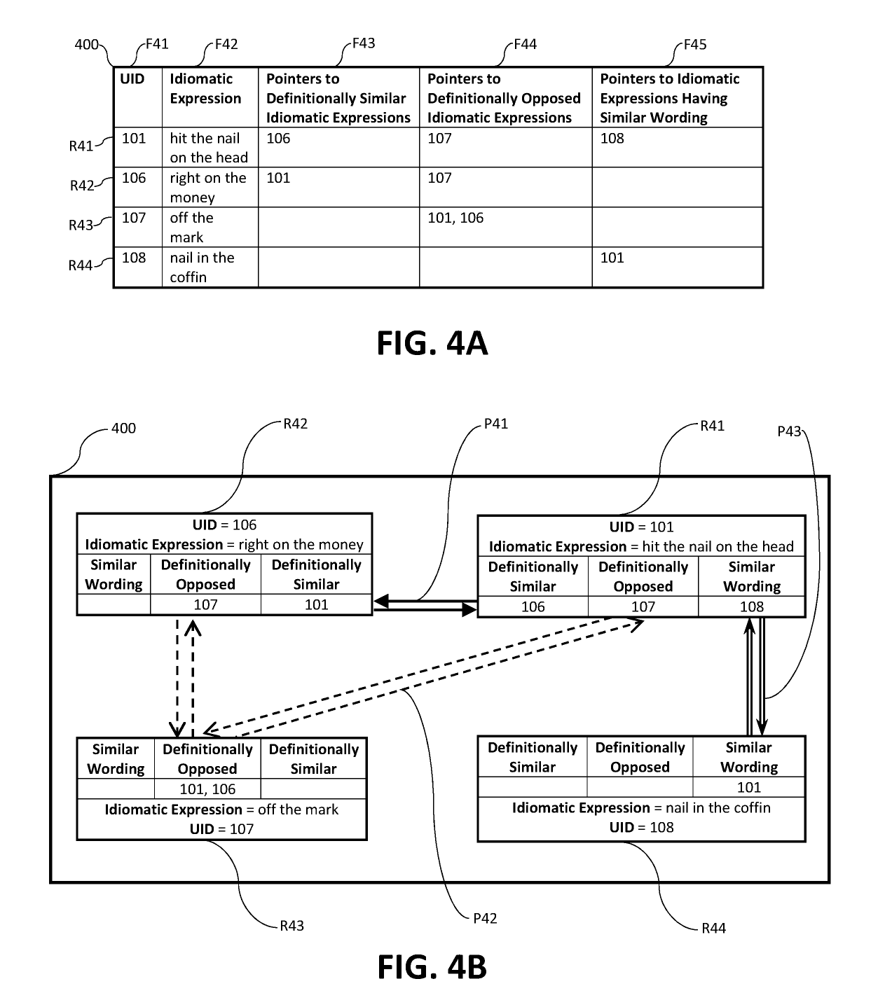

(vii) the pointer to the idiomatic expression “right on the money” (i.e., the UID “106” as the link address) that is definitionally similar to the database record's idiomatic expression “hit the nail on the head,” such as the pointer stored in database field F43 of database table 400 described in detail below with reference to FIGS. 4A-B;

(viii) the pointer to the idiomatic expression “off the mark” (i.e., the UID “107” as the link address) that is definitionally opposed to the database record's idiomatic expression “hit the nail on the head,” such as the pointer stored in database field F44 of database table 400 described in detail below with reference to FIGS. 4A-B; and

(ix) the pointer to the idiomatic expression “nail in the coffin” (i.e., the UID “108” as the link address) that contains similar wording to the database record's idiomatic expression “hit the nail on the head,” such as the pointer stored in database field F45 of database table 400 described in detail below with reference to FIGS. 4A-B.

It is to be understood that in an effort not to obscure the present disclosure in unnecessary detail that the database tables depicted in the diagrams of FIGS. 2-4B may contain additional database fields not shown therein. Additionally or alternatively, the database tables depicted in the diagrams of FIGS. 2-4B may omit some of the database fields shown therein. Further, it is to be understood that an idiomatic expression stored in the database tables of database 108 may not have data associated with the idiomatic expression stored in each and every database field of those database tables. That is to say, some of the database fields in the database tables associated with idiomatic expressions may not have a value stored for a particular idiomatic expression (i.e., a particular database record).

With reference to FIG. 2, a diagram is depicted of an embodiment of a database table 200 stored in database 108, according to aspects of the disclosure. In some embodiments, the database table 300 may include one or more database records, which may include for example, R21-R23. In some embodiments, each of the database records R21-R23 may store data (e.g., information) about a different idiomatic expression that is uniquely associated with the respective database record. In some embodiments, each of the database records R21-R23 may be comprised of one or more database fields F21-F24. In some embodiments, each of the database fields F21-F24 may store a data item associated with the respective database record (i.e., the respective idiomatic expression). As used herein, the term “explanatory description” may refer to any one or any combination of the database fields associated with a particular database record. In that regard, the explanatory description includes data associated with the particular idiomatic expression associated with the respective database record (i.e., the database record that contains the explanatory description).

In some embodiments, database field F21 may store a unique identifier (“UID”) associated with each database record. According to aspects of the disclosure, the UID is a unique key that identifies only one of the database records R21-R23. Thus, the UID also only identifies one particular idiomatic expression stored in database 108 (i.e., the idiomatic expression associated with the respective database record containing the UID). In some embodiments, the UID may be a numeric value, as depicted. For example, the UID with the numeric value “101” stored in database field F21 uniquely identifies the database record R21, and thus also identifies the idiomatic expression “hit the nail on the head.” In some embodiments, the UID may be a value other than a numerical value (e.g., alphanumeric value) that is capable of uniquely identifying one database record.

In some embodiments, database field F22 may store a string form of the idiomatic expression associated with each database record. For example, the string “kick the bucket” stored in database field F22 represents the idiomatic expression that is associated with database record R22. In other words, the idiomatic expression “kick the bucket” has its string form stored in database field F22 of database record R22.

In some embodiments, database field F23 may store the meaning of the idiomatic expression associated with each database record, as a string. For example, the string “in a state of financial independence and comfort” stored in database field F23 represents the meaning of the idiomatic expression associated with database record R23. In other words, the idiomatic expression “on easy street” has its meaning “in a state of financial independence and comfort” stored in database field F23 of database record R23.

In some embodiments, the database field F24 may store one or more examples of use associated with each database record, each as a string. For example, the string “If you hit the lottery, you'll be on easy street for the rest of your life!” is stored in database field F24 and represents an example of use of the idiomatic expression associated with the database record R23. In other words, the idiomatic expression “on easy street” has an associated example of use its meaning “If you hit the lottery, you'll be on easy street for the rest of your life!” stored in database field F24 of database record R23.

In some embodiments, the database table 200 may additionally or alternatively include one or more supplemental database fields. Each supplemental database field may store a data item associated with the idiomatic expression that is associated with each database record. Such supplemental database fields may be of great value and provide a significant advantage when utilized for particular real-world applications. For example, one supplemental database field may store pronunciation information associated with an idiomatic expression, which may be of great value for applications in which the end-user is a non-native speaker of the language. The one or more supplemental database fields may store data items including, for example, any one or any combination of: the language(s) associated with the idiomatic expression; the dialect(s) of a language associated with the idiomatic expression; alternate forms of the idiomatic expression; translations of the idiomatic expression in different languages; etymology information; syntax information; the type of idiomatic expression (e.g., metaphor); and any other information associated with the idiomatic expression that may be of use in particular applications.

With reference to FIG. 3, a diagram is depicted of an embodiment of a database table 300 stored in database 108, according to aspects of the disclosure. In some embodiments, the database table 300 may include one or more database records, which may include for example, R31-R33. In some embodiments, each of the database records R31-R33 may store data (e.g., information) about a different idiomatic expression that is uniquely associated with the respective database record. In some embodiments, each of the database records R31-R33 may be comprised of one or more database fields F31-F35. In some embodiments, each of the database fields F31-F35 may store a data item associated with the respective database record (i.e., the respective idiomatic expression).

In some embodiments, database field F31 may store a unique identifier (“UID”) associated with each database record. According to aspects of the disclosure, the UID is a unique key that identifies only one of the database records R31-R33. Thus, the UID also only identifies one particular idiomatic expression stored in database 108 (i.e., the idiomatic expression associated with the respective database record containing the UID). In some embodiments, the UID may be a numeric value, as depicted. For example, the UID with the numeric value “104” stored in database field F31 uniquely identifies the database record R32, and thus also identifies the idiomatic expression “for all intents and purposes.” In some embodiments, the UID may be a value other than a numerical value (e.g., alphanumeric value) that is capable of uniquely identifying one database record.

In some embodiments, database field F32 may store a string form of the idiomatic expression associated with each database record. For example, the string “for all intents and purposes” stored in database field F32 represents the idiomatic expression that is associated with database record R32. In other words, the idiomatic expression “for all intents and purposes” has its string form stored in database field F32 of database record R32.

In some embodiments, the database field F33 may store one or more common errors associated with the idiomatic expression associated with each database record, each as a string. A common error is the incorrect language used when a particular idiomatic expression was intended to be used, when such incorrect language has been used with sufficient frequency so as to be deemed “common” based on some predetermined criteria, analysis, and/or determination. For example, the common error “for all intensive purposes” is stored in database field F33 and is associated with the database record R32. Thus, the common error “for all intensive purposes” (stored in database field F33) is associated with the idiomatic expression “for all intents and purposes” (stored in database field F32).

In some embodiments, the database field F34 may store one or more keywords associated with the idiomatic expression associated with each database record, each as a string. In some embodiments, each keyword may be a content word contained within the idiomatic expression. Content words are those words that convey substantive meaning in a phrase or sentence, which may include nouns, verbs, adjectives, and most adverbs. Content words contrast with function words, which are those words that express grammatical relationships between other words in a phrase or sentence. Function words may include articles, prepositions, pronouns, particles, conjunctions, and the like. For example, the idiomatic expression “between a rock and a hard place” associated with database record R33 contains the content words “rock,” “hard,” and “place,” which are stored as keywords in database field F34. In some embodiments, the keywords may include any one or any combination of words (including words that are not content words) contained within the idiomatic expression, in which the keywords are identified and/or determined by any suitable process, heuristic, or algorithm known to a person of ordinary skill in the field of linguistics and/or the field of computer science.

In some embodiments, the database field F35 may store one or more base words associated with the idiomatic expression associated with each database record, each as a string. In some embodiments, a base word may be any unit of lexical meaning associated with a particular word contained within the idiomatic expression (i.e., a “base form” of the particular word). In the depicted embodiment, only those base words associated with a keyword (as discussed above with regard to database field F34) contained within the idiomatic expression are stored in database field F35. A unit of lexical meaning associated with a word may be, for example: the ‘lexeme’ of the word, the ‘lemma’ of the word, the ‘stem’ of the word, the ‘root’ of the word, or any other unit of lexical meaning associated with the word. In some cases, the base word associated with a keyword may be the same as the keyword itself. Lemmatization refers to the process of determining the lemma of a word, while stemming refers to the process of determining the stem of a word. In some instances, such processes may utilize a lookup table in order to retrieve the desired unit of lexical meaning (i.e., base word) associated with word. In some embodiments, the base words associated with an idiomatic expression may be determined by any suitable process, heuristic, or algorithm known to a person of ordinary skill in the field of linguistics and/or the field of computer science.

For example, the idiomatic expression “for all intents and purposes” associated with database record R32 has the associated base words “intent” and “purpose” that are stored in database field F35. This idiomatic expression “for all intents and purposes” contains the keywords “intents” and “purposes” (stored in database field F34) from which the base words “intent” and “purpose” may be determined and stored in database field F35. Advantageously, a search performed on the base words (i.e., database field F35) may provide superior results by identifying and returning additional idiomatic expressions that would not be returned by a similar search performed on the string forms of the idiomatic expressions (i.e., database field F32) and/or performed on the keywords (i.e., database field F34). As discussed in greater detail below with reference to FIG. 5 and in particular operation 504, such additional idiomatic expressions returned by a search employing base words may include an idiomatic expression that contains a different morphological form of a particular word contained within the input text string used to search database 108.

With reference to FIG. 4A, a diagram is depicted of an embodiment of a database table 400 stored in database 108, according to aspects of the disclosure. In some embodiments, the database table 400 may include one or more database records, which may include for example, R41-R44. In some embodiments, each of the database records R41-R44 may store data (e.g., information) about a different idiomatic expression that is uniquely associated with the respective database record. In some embodiments, each of the database records R41-R44 may be comprised of one or more database fields F41-F45. In some embodiments, each of the database fields F41-F45 may store a data item associated with the respective database record (i.e., the respective idiomatic expression).

In some embodiments, database field F41 may store a unique identifier (“UID”) associated with each database record. According to aspects of the disclosure, the UID is a unique key that identifies only one of the database records R41-R44. Thus, the UID also only identifies one particular idiomatic expression stored in database 108 (i.e., the idiomatic expression associated with the respective database record containing the UID). In some embodiments, the UID may be a numeric value, as depicted. For example, the UID with the numeric value “101” stored in database field F41 uniquely identifies the database record R41, and thus also identifies the idiomatic expression “hit the nail on the head.” In some embodiments, the UID may be a value other than a numerical value (e.g., alphanumeric value) that is capable of uniquely identifying one database record.

In some embodiments, database field F42 may store a string form of the idiomatic expression associated with each database record. For example, the string “hit the nail on the head” stored in database field F42 represents the idiomatic expression that is associated with database record R41. In other words, the idiomatic expression “hit the nail on the head” has its string form stored in database field F42 of database record R41.

In some embodiments, the database field F43 may store one or more pointers to definitionally similar idiomatic expressions (i.e., target idiomatic expressions determined to have generally similar meanings to the database record's idiomatic expression) associated with each database record, in which each pointer uses a UID to link to its target database record. In other words, the UID of a target database record is used by the pointer as the link address to that target database record. For example, the database record R42 stores a pointer in database field F43 to the target database record having the UID “101” (i.e., database record R41). It can thus be understood that the idiomatic expression “right on the money” (associated with database record R42) is definitionally similar to the idiomatic expression “hit the nail on the head” (associated with database record R41).

In some embodiments, the database field F44 may store one or more pointers to definitionally opposed idiomatic expressions (i.e., target idiomatic expressions determined to have generally opposing meanings to the database record's idiomatic expression) associated with each database record, in which each pointer uses a UID to link to its target database record. In other words, the UID of a target database record is used by the pointer as the link address to that target database record. For example, the database record R42 stores a pointer in database field F44 to the target database record having the UID “107” (i.e., database record R43). It can thus be understood that the idiomatic expression “right on the money” (associated with database record R42) is definitionally opposed to the idiomatic expression “off the mark” (associated with database record R43).

In some embodiments, the database field F45 may store one or more pointers to idiomatic expressions containing similar wording (i.e., target idiomatic expressions determined to contain similar words to the database record's idiomatic expression) that are associated with each database record, in which each pointer uses a UID to link to its target database record. In other words, the UID of a target database record is used by the pointer as the link address to that target database record. For example, the database record R41 stores a pointer in database field F45 to the target database record having the UID “108” (i.e., database record R44). It can thus be understood that the idiomatic expression “hit the nail on the head” (associated with database record R41) has similar wording to the idiomatic expression “nail in the coffin” (associated with database record R44). This determination may have been made, at least in part, because these 2 idiomatic expressions both contain the content word “nail.” The determination as to whether two idiomatic expressions have similar wording is discussed in further detail below with reference to FIG. 5, and in particular operation 520.

According to aspects of the disclosure, the pointers stored in the database fields F43-F45 may use any suitable identifier, address, or data item that is unique to a particular database record in order to link to a target database record. For example, in some embodiments, the pointers stored in the database fields F43-F45 may use memory addresses (including both physical addresses and/or logical addresses) to link to a target database record instead of using a UID. It should be understood that the terms “reference” and “referencing” may also be used to describe a pointer, and that various terminology may be used to describe the same pointer consistently. For example, all of the following statements are consistent with one another: “the database record R41 stores a pointer to the database record R42;” “the database record R41 stores a pointer that links to database record R42;” “the database record R41 includes a pointer that references the database record R42;” and “the database record R41 including a pointer, the pointer referencing the database record R42.”

With reference to FIG. 4B, a block diagram is depicted of an embodiment of the database table 400 associated with FIG. 4A, according to aspects of the disclosure. As illustrated, the database table 400 may include one or more database records which may include, for example, R41-R44. The database records R41-R44 are comprised of one or more database fields F41-F45, which are discussed in greater detail above with reference to FIG. 4A. It should be understood, that while database fields F41-F45 are not individually labeled with reference numerals (i.e., reference numerals F41-F45) in FIG. 4B, these unlabeled database fields are a depiction of the same database fields F41-F45 that are depicted in FIG. 4A. Thus, by use of the UID associated with a particular database record R41-R44 and/or the value stored in an unlabeled database field associated with a particular database record R41-R44, one can readily ascertain the reference numeral that would be associated with the particular unlabeled database field by making a simple comparison between FIG. 4A and FIG. 4B (which both depict the same database table 400).

As discussed above with reference to FIG. 4A, the database field F43 may store one or more pointers to definitionally similar idiomatic expressions (i.e., target idiomatic expressions determined to have generally similar meanings to the database record's idiomatic expression) associated with each database record, in which each pointer uses a UID to link to its target database record. In other words, the UID of a target database record is used by the pointer as the link address to that target database record. As illustrated in FIG. 4B, the arrows with a single solid line are visual representations of pointers to definitionally similar idiomatic expressions. For example, the arrow P41 with a single solid line is a visual representation of a pointer from the database record R41 associated with the idiomatic expression “hit the nail on the head” to the database record R42 associated with the definitionally similar idiomatic expression “right on the money.”

As discussed above with reference to FIG. 4A, the database field F43 may store one or more pointers to definitionally opposed idiomatic expressions (i.e., target idiomatic expressions determined to have generally opposing meanings to the database record's idiomatic expression) associated with each database record, in which each pointer uses a UID to link to its target database record. In other words, the UID of a target database record is used by the pointer as the link address to that target database record. As illustrated in FIG. 4B, the arrows with a dashed line are visual representations of pointers to definitionally opposed idiomatic expressions. For example, the arrow P42 with a dashed line is a visual representation of a pointer from the database record R43 associated with the idiomatic expression “off the mark” to the database record R41 that is associated with the definitionally opposed idiomatic expression “hit the nail on the head.”

As discussed above with reference to FIG. 4A, the database field F43 may store one or more pointers to idiomatic expressions determined to have similar wording (i.e., target idiomatic expressions determined to contain similar words to the database record's idiomatic expression) associated with each database record, in which each pointer uses a UID to link to its target database record. In other words, the UID of a target database record is used by the pointer as the link address to that target database record. As illustrated in FIG. 4B, the arrows with a double line are visual representations of pointers to idiomatic expressions determined to have similar wording. For example, the arrow with a double line P43 is a visual representation of a pointer from the database record R41 associated with the idiomatic expression “hit the nail on the head” to the database record R44 associated with the idiomatic expression having similar wording “nail in the coffin.” This determination may have been made, at least in part, because these 2 idiomatic expressions both contain the content word “nail.”

FIGS. 5-6 include flowcharts illustrating processes according to various embodiments of the present disclosure. It is to be understood that in an effort not to obscure the present disclosure in unnecessary detail that the processes depicted in the flowcharts of FIGS. 5-6 may contain additional operations not shown therein. Additionally or alternatively, the processes depicted in the flowcharts of FIGS. 5-6 may omit some of the operations shown therein. The operations depicted in the flowcharts of FIGS. 5-6 are not intended to be limited to any particular order or sequence; rather, the operations may be performed in any order or sequence unless otherwise explicitly stated herein. In light of the present disclosure, alternative orders or sequences of the operations shown in the flowcharts of FIGS. 5-6 will be apparent to those of ordinary skill in the art, and thus such alternative orders or sequences are intended to be within the scope and spirit of the present disclosure.

With reference to FIG. 5, a flowchart is depicted of an embodiment of a process 500 performed by a computing device 100, according to aspects of the disclosure. Although in this embodiment the operations of the process 500 are described and illustrated as being performed by the computing device 100, in other embodiments, at least some of the operations of the process 500 may be performed by an independent computing device (e.g., a server, a client device, etc.) that may directly or indirectly communicate with the computing device 100. The independent computing device may be any suitable computing device, as described above with reference to FIG. 1, that is capable of performing at least some of the operations of the process 500. Further, in some embodiments, at least some of the operations performed by the computing device 100 may be performed on behalf of a respective user (e.g., a user of the computing device 100).

As discussed above, in some embodiments, the methods disclosed herein (including process 500 or any operation thereof) may be implemented as, for example: a part of a standalone computer program or web-based application (e.g., a local word processor, an online email client, etc.); a plugin (e.g., add-on, extension, etc.) for an existing computer program (e.g., a web browser, a word processor, a messaging application, etc.); a plugin for an existing web-based application (e.g., an online email service, an online search engine, etc.); a part of an application programming interface (API) that provides the validation process disclosed herein for a third-party computer program or web-based application; and/or any combination thereof. These exemplary implementations as well as other suitable means to implement the methods disclosed will be apparent to those of ordinary skill in the art.

In operation 502, the computing device 100 receives an input text string for validation of idiomatic expressions from a source. According to aspects of the disclosure, the input text string may be a string comprised of a sequence of characters that may represent, for example, a word, a phrase, a sentence, a paragraph, or any grammatical unit of language. In some embodiments, the input text string may be received from the source as a result of actions performed by the computing device 100. In some embodiments, the input text string may be received from the source in a manner that is not the result of actions performed by the computing device 100.

In some embodiments, the input text string may be received due to an intentional action of a user. For example, the user may perform the intentional action of selecting the input text string from a larger text, e.g., selecting a phrase within a larger paragraph in a word processor application. In another example, the user may perform the intentional action of inputting the input text string into an input text field in a web-based application, e.g., a query input box in an online email client. In some embodiments, the input text string may be received after being automatically identified through any suitable process, heuristic, or algorithm known to a person of ordinary skill in the art. For example, an input text string may be automatically identified each time the user types a punctuation mark (e.g., a period, a question mark, a comma, etc.) into a suitable program such as a word processor, in which the input text string is identified as a string that precedes the punctuation mark (e.g., the input text string is identified as the sentence preceding the period). In some embodiments, the input text string may be identified and received in near real-time by any suitable means known to a person of ordinary skill in the field of computer science. In some embodiments, the input text string may be identified as a text (or any part or substring thereof) that is contained within a computer document file (e.g., a “.pdf” file, a “.doc” file, etc.).

In some embodiments, the source of the input text string may be the computing device 100 (including components thereof and programs executed thereon). In some situations, the source of the input text string may be another operation within process 500. In particular, the input text string may be received from operation 514, for example during an iterative scenario as discussed below with reference to FIG. 5 and in particular operation 510. In some embodiments, the source of the input text string may be any suitable resource that is accessible by the computing device 100 via direct or indirect communication. Such a suitable resource may be capable of, for example: storing the input text string (e.g., memory); receiving the input text string (e.g., from a client device); retrieving the input text string (e.g., from an external database on a server); and/or otherwise obtaining the input text string (e.g., as direct input from a user). Suitable resources may include, but are not limited to, any suitable type of memory and/or any suitable type of computing devices (including components thereof and programs executed thereon). Suitable types of memory may include, but are not limited to, random-access memory (RAM), read-only memory (ROM), a hard disk (HD), a solid state drive (SSD), a flash memory, an optical disc storage (e.g, DVD, CD-ROM), network accessible storage (NAS), online cloud storage (including related cloud computing web services), the like, and/or any combination thereof. Suitable types of computing devices may include, but are not limited to, a server, a server system (e.g., a load-balanced server farm, a geographically distributed server system, etc.), a desktop computer, a laptop computer, a tablet computer, a smartphone, a smart consumer electronics device, the like, and/or any combination thereof.

In operation 504, the computing device 100 performs a search of database 108 based on the input text string received in operation 502 in order to identify a candidate set of idiomatic expressions. According to aspects of the disclosure, a search may be based on the input text string when one or more query terms used by the search are, for example: contained within the input text string (e.g., substrings, keywords as described above with reference to FIG. 3); derived from the input text string (e.g., base words as described above with reference to FIG. 3); or otherwise determined through use of the input text string by any suitable means or algorithm. Accordingly, such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

According to aspects of the disclosure, the search of database 108 based on the input text string may be performed using any suitable process, heuristic, or algorithm known to a person of ordinary skill in the art, such that the search results are determined, at least in part, based on the query terms from the input text string described above. In some embodiments, the search may be performed using any suitable string-matching algorithm, including those employing approximate matching techniques (e.g., fuzzy string searching algorithms). The search results may include idiomatic expressions that are each associated with a particular database record in a database table stored in database 108.

As discussed in greater detail above with reference to FIG. 3, a base word may be any unit of lexical meaning associated with a particular word. A unit of lexical meaning may be, for example: the ‘lexeme’ of the word, the ‘lemma’ of the word, the ‘stem’ of the word, the ‘root’ of the word, or any other unit of lexical meaning associated with the word. Advantageously, when the query terms used by the search are base words, the search results may include additional idiomatic expressions that would not necessarily be returned using other query terms. As explained in more detail below, such additional idiomatic expressions may include an idiomatic expression that contains a different morphological form of a particular word contained within the input text string.

The morphological forms of a word are different but related versions of the same word, in which both forms share a common base word. The lexicon of many languages includes various morphological forms of the same word. The morphological forms of a word may differ due to, for example: the use of prefixes (i.e., alternate beginning of a word); the use of suffixes (i.e., alternate ending of a word); the pluralization of the word (e.g., adding the letter ‘s’ to the end of a word, a change such as from “goose” to “geese”); the conjugation of a verb (e.g., a change in verb tense from “fly” to “flies,” a change in verb tense from “kick” to “kicked”); etc.

While the various morphological forms of a word are related, a search that does not use base words as query terms may fail to return certain relevant idiomatic expressions as search results, merely due to those relevant idiomatic expressions containing a different morphological form of a particular word contained in the input text string. As an example, given the input text string “the goose flies,” in some embodiments a search that does not use base words as query terms may not return the hypothetical idiomatic expression “the geese fly” as a search result, even though the words “goose” and “geese” are different morphological forms of the same word and the words “flies” and “fly” are different morphological forms of the same word. Thus, in some embodiments, a search may fail to return a relevant idiomatic expression as a result when the search does not use base words as query terms.

Advantageously, the use of base words as query terms by a search may be considered a form of query expansion that may improve the quality of the search results. Considering the example above having the input text string “the goose flies,” a search that uses base words as query terms may return the hypothetical idiomatic expression “the geese fly” as a search result, despite the two strings containing different morphological forms of the same words. In that regard, the use of base words as query terms may expand the set of search results in a manner that enhances the accuracy and performance of the search. While the use of some types of query terms may limit a search's capability to identifying and returning only a single version of an idiomatic expression (i.e., a version of the idiomatic expression containing particular morphological forms of its words), the use of base words as query terms may allow for multiple versions of the input text string to be searched simultaneously and may allow for various versions of the idiomatic expression to be identified and returned by the search.

Moreover, the use of base words as query terms by the search may provide significant benefits such as superior search results and a greater number of search results, in comparison to other types of query terms. The search results may be considered superior when they include an additional idiomatic expression that more accurately reflect what was intended to be returned by the search (e.g., a different form of an idiomatic expression), in comparison to a different search not using base words as query terms which may not return this additional idiomatic expression. Thus, the use of base words as query terms may improve a search's accuracy by returning results that more accurately reflect what was intended to be returned. Further, the additional idiomatic expressions returned by the search may include an idiomatic expression that contains a different morphological form of a particular word contained in the input text string, as exemplified with respect to the hypothetical idiomatic expression “the geese fly” discussed above.

The scope of the search of database 108 may include one or more database tables and a plurality of database records contained therein. In some embodiments, each database record may be associated with a different idiomatic expression that is uniquely associated with the respective database record, and each database record may be comprised of one or more database fields that are associated with the respective database record, as discussed in detail above with reference to FIGS. 2-4A. In some embodiments, the scope of the search may be narrowed in order to provide various benefits and/or achieve particular results.

Narrowing the scope of the search of database 108 may provide a number of advantages including, but not limited to, increased efficiency, increased performance, and/or increased effectiveness of the search. For instance, a narrowed search (i.e., a search having a narrowed scope) may return less non-relevant and/or unwanted results in comparison to a search that has not been narrowed. This increased effectiveness is due, at least in part, to the narrowed search being performed on a smaller set of data (i.e., a targeted set of data), which may eliminate certain potential results that include non-relevant and/or unwanted data from being returned by the search because those potential results are stored outside of the targeted set of data. A narrowed search may also use less computing resources (e.g., memory, processor time, network or internet bandwidth, etc.) and require less overall time to run the search and return the search results (e.g., a faster search response time), resulting in increased efficiency and/or increased performance. The efficiency and performance of a search have become increasingly important as end-users of systems, devices, and programs executed thereon have become accustomed to near real-time results in recent years.

In some embodiments, the scope of a search of database 108 may be narrowed in a variety of ways to provide the benefits discussed above and/or achieve particular results. For example, in some situations, the scope may be narrowed by restricting the search to a particular database field or a limited number of database fields in a database table, rather than searching all database fields in the database table. Additionally or alternatively, in some situations, the scope may be narrowed by restricting the search to only those database records having one or more stipulated values in one or more specified database fields.

In some embodiments, a narrowed search may be performed on database 108 by restricting the scope to a particular database field or a limited number of database fields in database table 300 (described above with reference to FIG. 3). For example, with reference to FIG. 6 and in particular operation 612 discussed below, a narrowed searched may be performed only on the string forms of idiomatic expressions stored in database table 300 by restricting the search to database field F32. In another example, with reference to FIG. 6 and in particular operation 614 discussed below, a narrowed searched may be performed only on common errors associated with idiomatic expressions stored in database table 300 by restricting the search to database field F33. In yet another example, with reference to FIG. 6 and in particular operation 616 discussed below, a narrowed searched may be performed only on keywords (e.g., content words) associated with idiomatic expressions stored in database table 300 by restricting the search to database field F34. In yet another example, with reference to FIG. 6 and in particular operation 618 discussed below, a narrowed searched may be performed only on base words (e.g., lexemes) associated with idiomatic expressions stored in database table 300 by restricting the search to database field F35.

Additionally or alternatively, in some embodiments, a narrowed search may be performed on database 108 by restricting the scope to only those database records having one or more stipulated values in one or more specified database fields. Such a narrowed search may have significantly increased performance, efficiency, and effectiveness in comparison to a search that was not so narrowed due, at least in part, to the narrowed search being performed on a lower number of database records.

As discussed above with reference to FIG. 2, in some embodiments database table 200 may include a supplemental database field that stores the language associated with an idiomatic expression (e.g., English, French) and another supplemental database field that stores the dialect of a language associated with the idiomatic expression (e.g., British Isles, North American). Thus, an exemplary narrowed search may be performed on only those database records in database table 200 that are associated with the language “English.” This exemplary search may be further narrowed by additionally restricting the search to only those database records that are associated with the dialect “British Isles.” It should be understood that a particular idiomatic expression may be associated with more than one language and/or more than one dialect of a language. For example, the English language and the French language may have particular idiomatic expressions in common, such as the idiomatic expression “je ne sais quoi.” In another example, the British Isles dialect of English and North American dialect of English may have some idiomatic expressions in common, while each dialect of English may also have distinct idiomatic expressions that are unique to the respective dialect.

As noted above, the search results returned from the search of database 108 based on the input text string in operation 504 may include idiomatic expressions that are each associated with a particular database record in a database table stored in database 108. In various embodiments, the search results may include any combination of data stored in database 108 that is associated with a particular idiomatic expression included in the search results. According to aspects of the disclosure, in various embodiments, any one or any combination of the idiomatic expressions returned as search results may be added to a candidate set of idiomatic expressions, which may be further utilized by other operations in process 500.

In operation 506, the computing device 100 determines a refined set of idiomatic expressions. According to aspects of the disclosure, the refined set of idiomatic expressions may be a subset of the candidate set of idiomatic expressions identified in operation 504. Further, in some embodiments, the refined set of idiomatic expressions may include those idiomatic expressions in the candidate set that each have an associated concordance score that meets or exceeds a predetermined concordance threshold value. According to aspects of the disclosure, the associated concordance score may indicate a degree of similarity between the respective idiomatic expression and the input text string. Thus, a concordance score associated with an idiomatic expression is calculated with respect to a particular input text string.

In some embodiments, the concordance score may be represented by a numerical value. As used herein, a greater value for the concordance score indicates a greater degree of similarity between the respective idiomatic expression and the input text string. In an exemplary embodiment, the concordance score may be an integer that is measured on a scale between 0 and 100. On this exemplary scale, a value of 0 may represent the lowest possible concordance score (i.e., the lowest degree of similarity between the idiomatic expression and the input text string, when the two strings have no similarity), a value of 100 may represent the highest possible concordance score (i.e., the highest degree of similarity between the idiomatic expression and the input text string, when the two strings are identical), and values between 0 and 100 may represent intermediate concordance scores (i.e., intermediate degrees of similarity) therebetween.

According to aspects of the disclosure, a concordance score may be determined based on a comparison between the input text string and the idiomatic expression with which the concordance score is associated. In some embodiments, the input text string may be compared against the string form of the idiomatic expression when determining its associated concordance score. Additionally or alternatively, in some embodiments, the input text string may be compared against the base words that are associated with the idiomatic expression (as described above with reference to FIG. 3) when determining its associated concordance score. The strings may be compared using any suitable process, heuristic, or algorithm known to a person of ordinary skill in the art.

According to aspects of the disclosure, the concordance score may be calculated based on a multitude of concordance factors and analyses thereof. Advantageously, the presently disclosed systems, methods, and computer-readable medium may provide for an integrated analysis of the multitude of concordance factors that would be difficult, if not impossible, to objectively, consistently, and meaningfully apply if presented to a user individually. The integrated analysis may include, for example, providing a concordance score associated with a particular idiomatic expression, in which the concordance score has taken into account one or more of the multitude of concordance factors.

The concordance score associated with an idiomatic expression may be calculated based on one or more concordance factors, in which a particular concordance factor may be determined based on a comparison between the input text string and the idiomatic expression. In some embodiments, when calculating the concordance score a weight (e.g., a multiplier, an importance coefficient) may be applied to at least one of the concordance factors used in the calculation. Thus, one of the concordance factors may be favored (i.e., weighed more heavily) over the remaining concordance factors used by the calculation.

In some embodiments, one concordance factor may be determined based on a comparison between the input text string and the idiomatic expression, in which the comparison may be performed utilizing a string distance function. A string distance function is a type of string metric that provides an indication of the difference between two strings being compared, i.e., quantifies how dissimilar the two strings are to one another, as would be understood by a person of ordinary skill in the field of computational linguistics. For example, in some embodiments, the string distance function may be an edit distance function, which determines the minimum number of single-character edits necessary to change one of the strings being compared into the other (e.g., changing the input text string into the idiomatic expression). Any suitable edit distance function known to a person of ordinary skill in the art may be used including, but not limited to: the Levenshtein distance, the Damerau-Levenshtein distance, the Jaro-Winkler distance, the Sørensen-Dice coefficient, and/or the Wagner-Fischer algorithm.

In some embodiments, one concordance factor may be determined based on a comparison between the input text string and the idiomatic expression, in which the comparison may be performed utilizing an n-gram based technique. An n-gram is a sequence of ‘n’ contiguous items contained within a string of text, in which the items may be letters, syllables, words (i.e., shingles), or other units in various applications and implementations. In some embodiments, the input text string and the idiomatic expression may each be converted (e.g., broken down) into sets of n-grams, and the sets of n-grams may be used to compare the two strings. The input text string and the idiomatic expression may be compared using any suitable n-gram based technique known to a person of ordinary skill in the field of computational linguistics.

In some embodiments, one concordance factor may be determined based on a comparison between the input text string and the idiomatic expression, in which an analysis may be performed on the set of words contained within the input text string and the set of words contained within the idiomatic expression. In some embodiments, the analysis may take into consideration all words contained within the two sets. In other embodiments, the analysis may only take into consideration a limited subset of the words contained within the two sets. For example, the analysis may only take into consideration content words (and not function words), as are described in further detail above with reference to FIG. 3.

Additionally or alternatively, in some embodiments, the analysis may only take into consideration words having a frequency in the English language corpus that is below a predetermined threshold (e.g., less commonly used words in the language). As will be understood by a person of ordinary skill in the field of linguistics, each word in a language corpus may have an associated frequency that indicates the number of occurrences of the respective word in the language corpus (i.e., the “frequency of occurrence”). Common words in a language have higher frequencies of occurrence than rare words in the language which have lower frequencies of occurrence. Further, commonly used words having high frequencies of occurrence (e.g., the, you, be, as, not, have, etc.) may be less meaningful when comparing the two strings, and thus such high frequency words may not be taken into consideration by the analysis if their frequency is equal to or above the predetermined threshold.

In some embodiments, the analysis performed on the set of words contained within the input text string and the set of words contained within the idiomatic expression may analyze a number of metrics including, but not limited to, one or more of: the number of words that the two sets share have in common (i.e., words that the two sets share); the percentage of words in the input text string's set that are in common with the words in the idiomatic expression's set; the order of the words as they appear in the input text string and the idiomatic expression, respectively (i.e., the order of occurrence of the words within the string); and/or the frequencies of occurrence associated with the words in the two sets.

In some embodiments, the frequencies of occurrence associated with the words in the two sets may be used as a weights (e.g., a multiplier, an importance coefficient) that are applied during the determination of this concordance factor. For example, a word having a high frequency of occurrence (e.g., a commonly used word) may have a low weight applied to it, whereas a word having a low frequency of occurrence (e.g., a rare word) may have a high weight applied to it. Further, a word having a high frequency of occurrence (e.g., the, you, be, as, not, have, etc.) may be less meaningful when comparing the two strings, and thus such a word may have a low weight applied to it which in turn may lower the words the impact on this concordance factor.

In some embodiments, the order of occurrence of the words within the two strings may be taken into account when calculating the concordance score. The order of occurrence is an important factor when considering the similarity between two strings, and is particularly important in the context of idiomatic expressions which generally have syntactic fixedness (i.e., the order of the words is not optional). Thus, in some embodiments, the order of occurrence in the input text string may be compared against the order of occurrence in the idiomatic expression with respect to those particular words that the two sets share (i.e., that the two strings share). It is therefore to be understood that an idiomatic expression may have a higher concordance score when it has the same or similar order of occurrence of the words that it shares with the input text string, in comparison to another idiomatic expression that does not have the same or similar order of occurrence of those words. For example, in some embodiments, an order metric may be calculated based on the level of similarity between the order of occurrence in input text string and the order of occurrence in the idiomatic expression with respect to the words that the two strings share, and this order metric may be used as a weight (e.g., a multiplier, an importance coefficient) that is applied during the determination of this concordance factor.

In some embodiments, one concordance factor may be determined based on additional data and additional criteria that may be pertinent, and of value to, the concordance score associated with an idiomatic expression. Any suitable analytic technique known to those of ordinary skill in the art may be used on the additional data and the additional criteria in order to determine this concordance factor.

As discussed above, the concordance score associated with an idiomatic expression may be calculated based on one or more concordance factors. Additionally, in some embodiments, a weight (e.g., a multiplier, an importance coefficient) may be applied to at least one of the concordance factors used in the calculation of the concordance score. Thus, one of the concordance factors may be favored (i.e., weighed more heavily) over the remaining concordance factors used by the calculation. In some embodiments, the concordance score may be determined by any suitable statistical method for combining multiple data sources known to a person of ordinary skill in the field of statistics. For example, in some embodiments, a statistical meta-analysis may be employed which combines the concordance factors in order to determine the concordance score. In other embodiments, the concordance score may be determined by any suitable process, heuristic, or algorithm known to a person of ordinary skill in the art.

In some embodiments, the concordance score associated with an idiomatic expression may be assigned a stipulated value in certain scenarios rather than the concordance score being calculated in the manner described above. In an exemplary scenario, an idiomatic expression in the candidate set may be a “matched idiomatic expression,” which may have been added to the candidate set in operation 610 for example, as discussed below with reference to FIG. 6. Further, the matched idiomatic expression may be an idiomatic expression determined to match the input text string (as described in detail below in operations 602-604, for example) or may be an idiomatic expression associated with a comma error determined to match the input text string (as described below in operations 606-608, for example). In some embodiments, the matched idiomatic expression may have a stipulated value assigned to its associated concordance score. For example, the matched idiomatic expression may have a value assigned to its associated concordance score that is greater than or equal to the predetermined concordance threshold value (e.g., a value of 75) and less than the highest possible concordance score (e.g., a value of 100 on the scale between 0 and 100, described above). In another example, the matched idiomatic expression may have a value assigned to its concordance score that represents the highest possible concordance score (e.g., a value of 100 on the scale between 0 and 100, described above).

As discussed in greater detail above, a refined set of idiomatic expressions is determined in this operation, in which the refined set of idiomatic expressions may be a subset of the candidate set of idiomatic expressions identified in operation 504. In some embodiments, the refined set of idiomatic expressions may include those idiomatic expressions in the candidate set that each have an associated concordance score that meets or exceeds a predetermined concordance threshold value. In an exemplary embodiment discussed in greater detail above, the concordance score may be an integer value that is measured on a scale between 0 and 100, in which a value of 0 may represent the lowest possible concordance score, a value of 100 may represent the highest possible concordance score, and values between 0 and 100 may represent intermediate concordance scores therebetween. In an exemplary embodiment, the predetermined concordance threshold value may be 75. Thus, idiomatic expressions in the candidate set that have an associated concordance score greater than or equal to the value 75 may be added to the refined set of idiomatic expressions, which may be further utilized by other operations in process 500.

In operation 508, the computing device 100 determines whether at least one idiomatic expression included in the refined set of idiomatic expressions has an associated concordance score that meets or exceeds a predetermined refinement threshold value (i.e., the “primary determination of this operation 508”). According to aspects of the disclosure, the refined set of idiomatic expressions determined in operation 506 may be a subset of the candidate set of idiomatic expressions previously identified in operation 504. As discussed above in operation 506, the refined set of idiomatic expressions may include those idiomatic expressions in the candidate set that each have an associated concordance score that meets or exceeds the predetermined concordance threshold value.

According to aspects of the disclosure, the predetermined refinement threshold value may be greater than or equal to the predetermined concordance threshold value in various embodiments. In some embodiments where the predetermined refinement threshold value is equal to the predetermined concordance threshold value, the primary determination of this operation 508 may have a positive outcome if the refined set of idiomatic expressions is not an empty set (i.e., if the refined set contains at least one idiomatic expression), in which case the process 500 may proceed to operation 516 as discussed below. As discussed above, the idiomatic expressions in the refined set have associated concordance scores that meet or exceed the predetermined concordance threshold value, thus those same associated concordance scores necessarily also meet or exceed a predetermined refinement threshold value that is equal to the predetermined concordance threshold value.

In some embodiments where the predetermined refinement threshold value is greater than the predetermined concordance threshold value, the use of the predetermined refinement threshold value in this operation may add an additional layer of refinement to the validation process disclosed herein, which in some situations may lead to process 500 outputting superior results (e.g., more accurate results, more complete results, etc.) in comparison to another embodiment that does not so use the predetermined refinement threshold value.

In an exemplary scenario where at least one idiomatic expression included in the refined set of idiomatic expressions has an associated concordance score that meets or exceeds the predetermined refinement threshold value, the process 500 may proceed to operation 516 as discussed below. It may thus be understood that an idiomatic expression having an associated concordance score that meets or exceeds the predetermined refinement threshold value has been determined by the validation process disclosed herein to be sufficiently similar to the input text string so as to allow process 500 to advance towards a point where results may eventually be output (e.g., outputting idiomatic expressions in operation 522).

In an exemplary scenario where no idiomatic expression included in the refined set of idiomatic expressions has an associated concordance score that meets or exceeds the predetermined refinement threshold value (i.e., no idiomatic expression has yet been determined by the validation process to be sufficiently similar to the input text string), the process 500 may proceed to operation 510 and thus may invoke an iterative scenario (discussed in greater detail below with regard to operation 510) in which at least some of the operations 502-514 may be repeated iteratively by process 500 in some circumstances.

The iterative scenario being invoked as a result of the use of the predetermined refinement threshold value in this operation may add an additional layer of refinement to the validation process, due in part to operations 510-514 being performed as a result of the primary determination of this operation 508 having a negative outcome as discussed below. In operations 510-514, each discussed in greater detail below, a substring contained within the input text string may be determined and then selected for use as a new input text string upon which to perform the validation process disclosed herein beginning at operation 502 (which receives the substring for use as a new input text string from operation 514 during the iterative scenario). Thus, it may be understood that the input text string is refined to a substring during the iterative scenario, so as to hone in on a potentially more important substring contained therein (e.g., to hone in on an idiomatic expression that is a substring contained within a longer sentence that is the input text string).

For example, the input text string may be the sentence “I think you hit the nail on the head,” which contains the idiomatic expression “hit the nail on the head” as a substring within the input text string. In some embodiments, the search performed based on this input text string in operation 504 may return the idiomatic expression stored in database 108 “hit the nail on the head” as a search result (i.e., the “idiomatic expression search result”). The concordance score associated with the idiomatic expression search result (e.g., 75 on the scale between 0 and 100) indicates a degree of similarity between the idiomatic expression search result “hit the nail on the head” and the input text string “I think you hit the nail on the head.” It will be understood by a person of ordinary skill in the art that but for the additional words “I think you” within the input text string, the input text string would match the idiomatic expression search result, and thus in some embodiments the idiomatic expression search result would have the highest possible associated concordance score (e.g., 100 on the scale between 0 and 100 described above). Therefore, the concordance score associated with the idiomatic expression search result is lowered by 25 (i.e., a score of 100 versus 75) due to the inclusion of the additional words “I think you” in the input text string. In an exemplary embodiment, in which the predetermined concordance threshold value is 70 and the predetermined refinement threshold value is 80, the concordance score associated with the idiomatic expression search result (i.e., 75) is able to exceed the predetermined concordance threshold value at issue in operation 506, but is unable to meet or exceed the predetermined refinement threshold value at issue in the primary determination of this operation 508. This situation may be more likely to occur when the input text string is a larger grammatical unit (e.g., a sentence) that contains an idiomatic expression therein.

Further to the example above, since the concordance score associated with the idiomatic expression search result (i.e., 75) is unable to meet or exceed the predetermined refinement threshold value (i.e., 80), the primary determination of this operation 508 will have a negative outcome and process 500 may proceed to operation 510, which may invoke an iterative scenario as described above that includes performing operations 510-514. Advantageously, the determination and selection of a substring in operations 510-514 enables the validation process to refine the input text string and hone in on a potentially more important substring contained therein (e.g., an idiomatic expression contained within a longer sentence that is the input text string). The ability to hone in on important substrings within the input text string is of great value when the initial input text string received by operation 502 is a large grammatical unit such as a sentence or a paragraph, for example.

Further to the example above, in operation 514 the substring “hit the nail on the head” contained within the input text string may be selected for use as a new input text string upon which to perform the validation process disclosed herein, beginning at operation 502 which receives the substring for use as a new input text string from operation 514. The search performed based on the substring (instead of the previous input text string) in operation 504 may return the same idiomatic expression search result, i.e., the idiomatic expression stored in database 108 “hit the nail on the head.” However, the concordance score associated with the idiomatic expression search result will likely not be the same, because each concordance score is based in part on the string that was used to search database 108 in operation 504. Thus, the concordance score associated with the idiomatic expression search result (i.e., “hit the nail on the head”) when the search was performed based on the substring “hit the nail on the head” that matches (e.g., 100) may be higher than the previous concordance score (e.g., 75) when the search was performed based on the initial input text string received by operation 502. In other words, the associated concordance score may be higher, at least in part, due to the substring containing less additional words (that are not a part of, or related to, the idiomatic expression stored in database 108) than the initial larger input text string. Such additional words may negatively impact the concordance factors used to calculate the concordance score (e.g., increasing the edit distance determined by a string distance function), which are discussed in detail above in operation 506

Further to the iterative scenario demonstrated in the example above, when process 500 returns to this operation 508 after the substring has been selected for use by the validation process, the concordance score associated with the idiomatic expression “hit the nail on the head” stored in database 108 (i.e., 100, discussed above) now exceeds the predetermined refinement threshold value (i.e., 80) in contrast to the last time operation 508 was performed (when the initial input text string was being used by the validation process, discussed above). Thus, due to the use of the substring, the primary determination of this operation 508 may now have a positive result that allows process 500 to halt the iterative scenario and advance towards a point where results may eventually be output (e.g., outputting idiomatic expressions in operation 522).

As demonstrated by the example above, the use of the predetermined refinement threshold value in this operation resulted in an iterative scenario being invoked that added an additional layer of refinement to the validation process disclosed herein, in which the input text string was refined such that the validation process honed in on a significantly more important substring contained therein (i.e., a correct idiomatic expression contained within the larger initial input text string).

Upon a negative determination that no idiomatic expression included in the refined set of idiomatic expressions meets or exceeds a predetermined refinement threshold value, the process 500 may proceed to operation 510. Otherwise, upon a positive determination that at least one idiomatic expression included in the refined set of idiomatic expressions meets or exceeds a predetermined refinement threshold value, the process 500 may proceed to operation 516. In some embodiments, before the process 500 proceeds to operation 516, one or more of the idiomatic expressions in the refined set that do not meet or exceed the predetermined refinement threshold value may be removed from the refined set.

In operation 510, the computing device 100 determines a set of substrings contained within the input text string. According to aspects of the disclosure, the set of substrings may be determined by any suitable process, heuristic, or algorithm known to a person of ordinary skill in the field of linguistics and/or the field of computer science. In some embodiments, for example, the set of substrings may be determined using one or more hash functions, as would be known by a person of ordinary skill in the art. In some embodiments, the set of substrings may be identified from a substring index that has been determined from the input text string using any suitable means known to a person of ordinary skill in the art.

According to aspects of the disclosure, in some circumstances, the set of substrings may already contain at least one substring before operation 510 has been substantially performed. Further, in some embodiments, process 500 may be at least partially iterative in nature, whereby some of the operations of process 500 are repeated and performed more than once (e.g., via a recursive function, via a looping function, etc.). As illustrated in FIG. 5, in the depicted embodiment, at least some of the operations 502-514 may be repeated iteratively by process 500 in some circumstances (an “iterative scenario”) based upon the determinations made in operation 508 and operation 512.

In an iterative scenario, operation 510 may have already been performed at least once, and thus the set of substrings may have already been determined by operation 510 previously. In some embodiments and in an iterative scenario, upon a determination that the set of substrings already contains at least one substring before operation 510 has been substantially performed, the process 500 may proceed to operation 512 without operation 510 performing any further determination regarding substrings contained in the input text string. In other embodiments and in an iterative scenario, upon a determination that the set of substrings already contains at least one substring before operation 510 has been substantially performed, the operation 510 may continue to determine a second set of substrings contained within the input text string. In such a case, the set of substrings (that contained at least one substring before operation 510 has been substantially performed) may be fully or partially combined with, or replaced by, the second set of substrings.

In operation 512, the computing device 100 determines whether the set of substrings contained within the input text string is an empty set. Described in another manner, operation 512 determines whether at least one substring is contained within the set of substrings. If the set of substrings does not contain at least one substring, then the set of substrings is an empty set. Upon a positive determination that the set of substrings is an empty set, the process 500 may proceed to operation 522. Otherwise, upon a negative determination that the set of substrings is not an empty set (i.e., that at least one substring is contained within the set of substrings), the process 500 may proceed to operation 514.

In operation 514, the computing device 100 selects a substring upon which to perform validation of idiomatic expressions. According to aspects of the disclosure, the computing device 100 may select the substring from the set of substrings determined by operation 510. The substring may be selected by any suitable means and/or based upon any suitable analysis known to a person of ordinary skill in the art. In some embodiments, the set of substrings may be ranked by any suitable metric and/or analysis, and the substring having the highest (or lowest) rank within the set of substrings may be selected. For example, the set may be ranked based upon length of each substring, and the substring with the longest (or shortest) length may be selected.

In some embodiments, the set may be ranked based upon the number of keywords and/or base words (described above with reference to FIG. 3) contained within each substring, and the substring containing the most (or least) keywords or base words may be selected. In some of these embodiments, only those keywords or base words identified as “relevant” may be used to determine the ranking, such that the substring containing the most (or least) “relevant” keywords and/or base words may be selected. In some embodiments, a keyword or base word may be identified as “relevant” when its use as a query term during a search in operation 504 resulted in, or contributed to, at least one idiomatic expression being added to the candidate set. Advantageously, such embodiments determining rank based upon only “relevant” keywords and/or base words may have increased efficiency and performance, due to intelligently selecting a substring likely to lead to results that will satisfy operation 508 during an iterative scenario (as described above with reference to FIG. 5 and in particular operation 510). That is to say, intelligently selecting a substring may lead to a refined set that includes at least one idiomatic expression that satisfies operation 508 due to having an associated concordance score that meets or exceeds a predetermined refinement threshold value. As would be understood by a person of ordinary skill in the art, satisfying operation 508 may end the iterative scenario which in turn leads to the increased efficiency and performance of process 500.

Upon selecting the substring, the process 500 may proceed to operation 502 which receives the selected substring as an input text string. The selected substring may be removed from the set of substrings determined by operation 510, such that it cannot be selected once again by this operation 514 during an iterative scenario, as described above with reference to FIG. 5 and in particular operation 510.

In operation 516, the computing device 100 performs a search of database 108 to identify a set of idiomatic expressions that are definitionally similar to each of the idiomatic expressions in the refined set of idiomatic expressions. According to aspects of the disclosure, a first idiomatic expression may be considered definitionally similar to a second idiomatic expression, when the first idiomatic expression has a meaning that is generally similar to the meaning of the second idiomatic expression.

In some embodiments, the search of database 108 may be performed on database table 400, described in detail above with reference to FIG. 4A. In some embodiments, the database field F43 in database table 400 may store one or more pointers to definitionally similar idiomatic expressions that are associated with a particular database record. For example, database record R42 in database table 400 (associated with the idiomatic expression “right on the money”) contains a pointer in database field F43 to the definitionally similar idiomatic expression associated with the UID “101” (i.e., the database record R41 associated with the idiomatic expression “hit the nail on the head”). It can thus be understood that the idiomatic expression “right on the money” has a generally similar meaning to the idiomatic expression “hit the nail on the head,” as determined based upon the pointers contained in database field F43.

In some embodiments, for each of the idiomatic expressions in the refined set, the database table 400 may be searched for a database record that is associated with the respective idiomatic expression in the refined set. Further, for each database record associated with a particular idiomatic expression in the refined set, the database field F43 may store pointers to idiomatic expressions that are definitionally similar to that particular idiomatic expression in the refined set. Thus, the set of definitionally similar idiomatic expressions sought by this operation 516 may be identified via the pointers stored in database field F43 of the database records in database table 400 that are associated with idiomatic expressions in the refined set.

In operation 518, the computing device 100 performs a search of database 108 to identify a set of idiomatic expressions that are definitionally opposed to each of the idiomatic expressions in the refined set of idiomatic expressions. According to aspects of the disclosure, a first idiomatic expression may be considered definitionally opposed to a second idiomatic expression, when the first idiomatic expression has a meaning that is generally opposed to the meaning of the second idiomatic expression.

In some embodiments, the search of database 108 may be performed on database table 400, described in detail above with reference to FIG. 4A. In some embodiments, the database field F44 in database table 400 may store one or more pointers to definitionally opposed idiomatic expressions that are associated with a particular database record. For example, database record R42 in database table 400 (associated with the idiomatic expression “right on the money”) contains a pointer in database field F44 to the definitionally opposed idiomatic expression associated with the UID “107” (i.e., the database record R43 associated with the idiomatic expression “off the mark”). It can thus be understood that the idiomatic expression “right on the money” has a generally opposed meaning to the idiomatic expression “off the mark,” as determined based upon the pointers contained in database field F44.

In some embodiments, for each of the idiomatic expressions in the refined set, the database table 400 may be searched for a database record that is associated with the respective idiomatic expression in the refined set. Further, for each database record associated with a particular idiomatic expression in the refined set, the database field F44 may store pointers to idiomatic expressions that are definitionally opposed to that particular idiomatic expression in the refined set. Thus, the set of definitionally opposed idiomatic expressions sought by this operation 518 may be identified via the pointers stored in database field F44 of the database records in database table 400 that are associated with idiomatic expressions in the refined set.

In operation 520, the computing device 100 performs a search of database 108 to identify a set of idiomatic expressions that have similar wording to each of the idiomatic expressions in the refined set of idiomatic expressions. According to aspects of the disclosure, a first idiomatic expression may be considered to have similar wording to a second idiomatic expression, when the first idiomatic expression contains words that are similar to words contained in the second idiomatic expression. In some embodiments, all words contained within the idiomatic expressions may be considered when determining whether two idiomatic expression have similar wording. In other embodiments, only keywords contained within the idiomatic expression may be considered when determining whether two idiomatic expression have similar wording. For example, each keyword may be a content word (as opposed to a function word), as discussed in greater detail above with reference to FIG. 3. In some embodiments, two words may only be deemed “similar” when they are an exact match of one another. In other embodiments, two words may be deemed “similar” when they are different morphological forms of a particular word (e.g., the word “run” may be deemed similar to the word “ran”). In such a scenario, the two morphological forms of the particular words may thus share a base word, as discussed below with reference to FIG. 3.

In some embodiments, the search of database 108 may be performed on database table 400, described in detail above with reference to FIG. 4A. In some embodiments, the database field F45 in database table 400 may store one or more pointers to idiomatic expressions that have similar wording to the particular idiomatic expression that is associated with the database record. For example, database record R41 in database table 400 (associated with the idiomatic expression “hit the nail on the head”) contains a pointer in database field F45 to the idiomatic expression that has similar wording and is associated with the UID “108” (i.e., the database record R44 associated with the idiomatic expression “nail in the coffin”). It can thus be understood that the idiomatic expression “hit the nail on the head” has similar wording to the idiomatic expression “nail in the coffin,” as determined based upon the pointers contained in database field F45. This determination may have been made, at least in part, because these 2 idiomatic expressions both contain the content word “nail.”

In some embodiments, for each of the idiomatic expressions in the refined set, the database table 400 may be searched for a database record that is associated with the respective idiomatic expression in the refined set. Further, for each database record associated with a particular idiomatic expression in the refined set, the database field F45 may store pointers to idiomatic expressions that have similar wording to that particular idiomatic expression in the refined set. Thus, the set of idiomatic expressions sought by this operation 520, which have similar wording to each of the idiomatic expressions in the refined set, may be identified via the pointers stored in database field F45 of the database records in database table 400 that are associated with idiomatic expressions in the refined set.

In operation 522, the computing device 100 may output one or more sets of idiomatic expressions. According to aspects of the disclosure, operation 522 may output a refined set of idiomatic expressions determined by operation 506 and further refined by operation 508, as discussed in greater detail above. In various embodiments, the computing device 100 may additionally output one or more of the following sets of idiomatic expressions: a set of definitionally similar idiomatic expressions determined by operation 516; a set of definitionally opposed idiomatic expressions determined by operation 518; and/or a set of idiomatic expressions having similar wording determined by operation 520. In some embodiments, the computing device 100 may also output additional information associated with the idiomatic expressions included in any one or any combination of the foregoing sets that are output.

According to aspects of the disclosure, the additional information associated with a particular idiomatic expression may include any one or any combination of data associated with that particular idiomatic expression including, but not limited to:

(i) a unique identifier (“UID”) associated with the particular idiomatic expression, e.g., such as the UIDs stored in database field F21 of database table 200 described above with reference to FIG. 2;

(ii) a string form of the particular idiomatic expression, e.g., such as the string forms stored in database field F22 of database table 200 described above with reference to FIG. 2;

(iii) a meaning associated with the particular idiomatic expression, e.g., such as the meanings stored in database field F23 of database table 200 described above with reference to FIG. 2;

(iv) one or more examples of use associated with the particular idiomatic expression, e.g., such as the examples of use stored in database field F24 of database table 200 described above with reference to FIG. 2;

(v) one or more the common errors associated with the particular idiomatic expression, e.g., such the common errors stored in database field F33 of database table 300 described above with reference to FIG. 3;

(vi) one or more keywords that are associated with the particular idiomatic expression, e.g., such as the keywords stored in database field F34 of database table 300 described above with reference to FIG. 3;

(vii) one or more base words associated with the particular idiomatic expression, e.g., such as the base words stored in database field F35 of database table 300 described above with reference to FIG. 3;

(viii) one or more pointers to definitionally similar idiomatic expressions that are associated with the particular idiomatic expression, e.g., such as the pointers stored in database field F43 of database table 400 described above with reference to FIGS. 4A-B;

(ix) one or more pointers to definitionally opposed idiomatic expressions that are associated with the particular idiomatic expression, e.g., such as the pointers stored in database field F44 of database table 400 described above with reference to FIGS. 4A-B;

(x) one or more pointers to idiomatic expressions that contain similar wording to the particular idiomatic expression, e.g., such as the pointers stored in database field F45 of database table 400 described above with reference to FIGS. 4A-B;

(xi) the pronunciation information associated with the particular idiomatic expression;

(xii) the languages associated with the particular idiomatic expression;

(xiii) the dialects of a language associated with the particular idiomatic expression;

(xiv) alternate forms of the particular idiomatic expression;

(xv) a translation of the particular idiomatic expression in a different language;

(xvi) etymology information associated with the particular idiomatic expression;

(xvii) syntax information associated with the particular idiomatic expression;

(xviii) the type of idiomatic expression (e.g., metaphor); and

(xix) any other information associated with the particular idiomatic expression.

In various embodiments, the computing device 100 may output all, some, or none of the additional information associated with a particular idiomatic expression. Further, as discussed above, some of the additional information may be of great value to an end-user and/or provide a significant advantage when utilized for particular real-world applications. For example, the outputted additional information may include a meaning associated with the particular idiomatic expression that enables the end-user to confirm their understanding of the idiomatic expression. In another example, the outputted additional information may include one or more examples of use associated with the particular idiomatic expression that empowers the end-user to check whether their use of the particular idiomatic expression was correct. In another example, the outputted additional information may include a translation and/or pronunciation information associated with the particular idiomatic expression, either of which may be of great value for applications in which the end-user is a foreign speaker for whom the language is their second or third.

In some embodiments, the computing device 100 may output some, but not all, of the idiomatic expressions contained within a particular set of idiomatic expressions. In other words, the data included in the particular set may be narrowed (e.g., culled) such that only a subset of the idiomatic expressions may be output. For example, in some embodiments, only a subset of the refined set of idiomatic expressions may be output by the computing device 100. The subset of the refined set may include, for example, a limited number of idiomatic expressions from the refined set up to a predetermined maximum output number (e.g., a maximum of 10 idiomatic expressions from the refined set may be output in the subset). The subset of the refined set may include idiomatic expressions that are selected through a determination using any suitable metric and/or suitable analysis.

Additionally or alternatively, in some embodiments, the idiomatic expressions in the refined set may be ranked in order by their associated concordance scores, and the highest ranking idiomatic expressions (i.e., those having the highest concordance scores) may be output. In some embodiments, the highest ranking idiomatic expressions may be selected for inclusion in a subset of the refined set of idiomatic expressions that may be output (e.g., the 10 highest ranking idiomatic expressions in the refined set may be output in the subset). In some embodiments, when an idiomatic expression in the refined set is output, the concordance score associated with the idiomatic expression may also be output. In some embodiments, any one or any combination of the foregoing sets of idiomatic expressions discussed above may be similarly narrowed such that only a subset of the data included in the respective set may be output.

Limiting the number of idiomatic expressions (and associated additional information) that are output by the computing device 100 may result in particular advantages including, but not limited to: increased performance; use of less computing resources (e.g., memory use, processor time); use of less network and/or internet bandwidth; faster total response time between receipt of the input text string in operation 502 and outputting the results of process 500 in this present operation 522; and/or any combination thereof.

In some embodiments, the computing device 100 may output an indication as to whether an input text string (or a substring thereof) has been identified as a correct idiomatic expression by the validation process disclosed herein. In some embodiments, the input text string may be identified as a correct idiomatic expression when the input text string has been determined to match a particular idiomatic expression stored in database 108. In various embodiments, the input text string and the particular idiomatic expression may be deemed to match when it has been determined that there is (a) an identical match, (b) an equivalent match, and/or (c) an alternative match, with each type of match being discussed in greater detail below with reference to FIG. 6 and in particular operation 602. When the particular idiomatic expression deemed to match the input text string is output, the computing device 100 may optionally output an indication that the particular idiomatic expression is an identified correct idiomatic expression (as discussed in greater detail above). Additionally or alternatively, in some embodiments, the input text string may be identified as a correct idiomatic expression when an idiomatic expression in the refined set has an associated concordance score with the highest possible value (e.g., a score of 100 on the exemplary scale between 0 and 100 described above in operation 506). When the idiomatic expression in the refined set is output, the computing device 100 may optionally output an indication that the idiomatic expression in the refined set is an identified correct idiomatic expression (as discussed in greater detail above).

In some embodiments, the computing device 100 may output an indication as to whether an input text string (or a substring thereof) has been identified as an incorrect idiomatic expression by the validation process disclosed herein. In some embodiments, the input text string may be identified as an incorrect idiomatic expression when the input text string has been determined to match a particular common error associated with a particular idiomatic expression stored in database 108. In various embodiments, the input text string and the particular common error may be deemed to match when it has been determined that there is (a) an identical match, (b) an equivalent match, and/or (c) an alternative match, with each type of match being discussed in greater detail below with reference to FIG. 6 and in particular operation 602. When the particular idiomatic expression associated with the particular common error deemed to match the input text string is output, the computing device 100 may optionally output an indication that the particular idiomatic expression is a suggested correct idiomatic expression (as discussed in greater detail above). Additionally or alternatively, in some embodiments, the input text string may be identified as an incorrect idiomatic expression when no idiomatic expression in the refined set has an associated concordance score with the highest possible value (e.g., a score of 100 on the exemplary scale between 0 and 100 described above in operation 506). When such an idiomatic expression in the refined set is output, the computing device 100 may optionally output an indication that the idiomatic expression in the refined set is a suggested correct idiomatic expression (as discussed in greater detail above).

With reference to FIG. 6, a flowchart is depicted of an embodiment of a subprocess associated with performing a search of the database, based on the input text string, to identify a candidate set of idiomatic expressions, as shown by operation 504 in FIG. 5, according to aspects of the disclosure.

In operation 602, the computer device 100 performs a search of the string forms of idiomatic expressions stored in database 108 to identify an idiomatic expression having a string form that matches the input text string received in operation 502. In other words, database 108 may be searched based on the input text string in order to identify an idiomatic expression that matches the input text string, in which the string form of the idiomatic expression is used to determine whether there is a match. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 200 described in greater detail above with reference to FIG. 2. In some embodiments, the database field F22 of database table 200 may store the string form of the idiomatic expression associated with a particular database record in database table 200. Accordingly, the search may be performed on database field F22 to attempt to identify an idiomatic expression that matches the input text string (an “identified idiomatic expression”), and the identified idiomatic expression may be returned as a search result. It should be understood that the identified idiomatic expression returned as a search result is associated with a particular database record in database table 200.

According to aspects of the disclosure, the determination as to whether a particular idiomatic expression matches the input text string may be implemented in a variety of ways. In various embodiments, the input text string and a particular idiomatic expression may be deemed to match when it has been determined that there is (a) an identical match, (b) an equivalent match, and/or (c) an alternative match, as discussed in greater detail below with respect to each type of match.

In some embodiments, the input text string and the string form of an idiomatic expression may be deemed to match when there is an identical match. An identical match may be recognized when the two strings are determined to be identical to one another. For example, the input text string “kick the bucket” may be deemed an identical match of the idiomatic expression “kick the bucket,” because the two strings are identical to one another. In contrast, despite being similar, the input text string “kicked the bucket” may not be deemed an identical match of the idiomatic expression “kick the bucket,” since the two strings are not identical to one another because of a minor difference due to a verb tense. The idiomatic expression contains the verb “kick” in present tense, in contrast to the input text string which contains the same verb in past tense that includes the suffix “ed” to form the word “kicked.”

A particular word may have different morphological forms, as discussed in greater detail above with reference to FIG. 5 and in particular operation 504. The different tenses of a verb are one example of a particular word (e.g., the verb) having different morphological forms (e.g., the verb tenses). As exemplified above, two strings may not be deemed an identical match of one another when they are otherwise identical except for each string containing a different morphological form of a particular word (e.g., “kick the bucket” and “kicked the bucket”). Thus, in some embodiments where the input text string and a particular idiomatic expression are only deemed to match when there is an identical match, the search may fail to identify and return a particular idiomatic expression in database 108 that is a “different form of the same idiomatic expression” represented by the input text string (e.g., the two strings are otherwise identical except for each containing a different morphological form of a particular word).

In some embodiments, the input text string and the string form of an idiomatic expression may be deemed to match when there is an equivalent match. An equivalent match may be recognized when the two strings are determined to be different forms of the same idiomatic expression (e.g., the two strings are otherwise identical except for each containing a different morphological form of a particular word as discussed above). For example, the input text string “kicked the bucket” may be deemed an equivalent match of the idiomatic expression “kick the bucket,” since they are different forms of the same idiomatic expression which are otherwise identical (including their respective word orders) except for each contain a different morphological form of the verb “kick.”

In some embodiments, the input text string and the string form of an idiomatic expression may be deemed to match when there is an alternative match. In some embodiments, an alternative match may be recognized when an identical match or an equivalent match has been determined between the input text string and an alternate form of an idiomatic expression. In some embodiments, an alternate form of an idiomatic expression may be predetermined (e.g., a different version of the same idiomatic expression) and may be stored in a supplemental database field in database table 200, as discussed above with reference to FIG. 2. For example, an alternative form of an idiomatic expression stored in the supplemental database field may contain different wording than the primary form of the idiomatic expression stored in database field F22, while still being considered two forms of the same idiomatic expression despite the different wording. For instance, such different wording may include the use of different function words in the same location within the two forms of the idiomatic expression. As described above with reference to FIG. 3, function words express grammatical relationships between other words in a phrase, rather than conveying the substantive meaning of the phrase. Additionally or alternatively, in some embodiments, an alternative match may be recognized when the input text string is determined to match the idiomatic expression though the use of any suitable process, heuristic, or algorithm for string matching and/or string comparison that is known to a person of ordinary skill in the field of linguistics and/or the field of computer science.

According to aspects of the disclosure, an identified idiomatic expression (i.e., an idiomatic expression determined to match the input text string) may be returned as a search result of the search performed in operation 602. As discussed above, in various embodiments, an identified idiomatic expression may be deemed to match the input text string when it has been determined that there is (a) an identical match, (b) an equivalent match, and/or (c) an alternative match.

In operation 604, the computing device 100 determines whether an idiomatic expression that matches the input text string has been identified. According to aspects of the disclosure, the computing device 100 receives the results returned by the search performed by operation 602 (i.e., the “search results”). Upon a positive determination, that the search results include an idiomatic expression identified as a match with respect to the input text string, the subprocess may proceed to operation 610. Otherwise upon a negative determination, that the search results do not include an idiomatic expression identified as a match with respect to the input text string, the subprocess may proceed to operation 606.

In operation 606, the computer device 100 performs a search of the common errors associated with idiomatic expressions stored in database 108 to identify an idiomatic expression that is associated with a common error that matches the input text string received in operation 502. In other words, database 108 may be searched based on the input text string in order to identify an idiomatic expression that is associated with a common error that matches the input text string, in which the string form of the common error is used to determine whether there is a match. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 300 described in greater detail above with reference to FIG. 3. In some embodiments, the database field F33 of database table 300 may store one or more common errors associated with the idiomatic expression associated with a particular database record in database table 300. For example, with respect to database record R32 in database table 300, the common error “for all intensive purposes” (stored in database field F33) is associated with the idiomatic expression “for all intents and purposes” (stored in database field F32). Accordingly, the search may be performed on database field F33 to attempt to identify a common error that matches the input text string (an “identified common error”), and the idiomatic expression that is associated with the identified common error may be returned as a search result. It should be understood that the idiomatic expression returned as a search result is associated with a particular database record in database table 300.

According to aspects of the disclosure, the determination as to whether a common error matches the input text string may be implemented in a variety of ways. In various embodiments, the input text string and a particular common error may be deemed to match when it has been determined that there is (a) an identical match, (b) an equivalent match, and/or (c) an alternative match. Each of these types of matches (a)-(c) are discussed in greater detail above with respect to operation 602. Determining a match with respect to the input text string in operation 602 is substantially similar to determining a match with respect to the input text string in operation 606, and the determinations are performed in a substantially similar manner, except that in operation 602 the match is determined against idiomatic expressions whereas in operation 606 the match is determined against common errors that are associated with particular idiomatic expressions. An idiomatic expression that is associated with an identified common error (i.e., a common error determined to match the input text string) may be returned as a result of the search performed by operation 606.

In operation 608, the computing device 100 determines whether an idiomatic expression associated with a common error that matches the input text string has been identified. According to aspects of the disclosure, the computing device 100 receives the results returned by the search performed by operation 606 (i.e., the “search results”). Upon a positive determination, that the search results include an idiomatic expression identified as being associated with a comma error that matches the input text string, the subprocess may proceed to operation 610. Otherwise upon a negative determination, that the search results do not include an idiomatic expression identified as being associated with a comma error that matches the input text string, the subprocess may proceed to operation 612.

In operation 610, the computing device 100 includes the identified idiomatic expression in a candidate set of idiomatic expressions. According to aspects of the disclosure, the computing device 100 receives the results returned by the search performed by operation 602 and/or the results returned by the search performed by operation 606 (i.e., the “search results”). In some embodiments, the search results may include an identified idiomatic expression, which may be an idiomatic expression identified as a match with respect to the input text string (described above in operations 602-604) or an idiomatic expression identified as being associated with a comma error that matches the input text string (described above in operations 606-608). In various embodiments, any one or any combination of identified idiomatic expressions may be added to a candidate set of idiomatic expressions, after which the process may proceed to operation 506 which may utilize the candidate set of idiomatic expressions.

In operation 612, the computing device 100 performs a search, based on the input text string received in operation 502, of the string forms of idiomatic expressions stored in database 108, and includes the idiomatic expressions associated with the search results in a candidate set of idiomatic expressions. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 300 described in detail above with reference to FIG. 3. In some embodiments, the database field F32 of database table 300 may store the string form of the idiomatic expression associated with a particular database record in database table 300. Accordingly, the search may be performed on database field F32 using any suitable process, heuristic, or algorithm known to a person of ordinary skill in the art, such that the search results are determined based on the query terms (from the input text string) and the string forms of idiomatic expressions stored in database field F32. In some embodiments, the search may be performed using any suitable string-matching algorithm, including those employing approximate matching techniques (e.g., fuzzy string searching algorithms). The search results may include idiomatic expressions that are each associated with a particular database record stored in database table 300.

It is to be understood that an idiomatic expression returned as a search result in operation 612 may not match the input text string, in contrast to the search in operation 602 that is similarly performed on the string forms of idiomatic expressions stored in database 108 and which requires a match as discussed above. For example, the input text string “nail in the box” would not be deemed to match the idiomatic expression “nail in the coffin” (stored in database record R34 in database 300), and so this idiomatic expression would not be returned as a search result in operation 602, whereas in some embodiments this idiomatic expression may be returned as a search result in operation 612 due to it having the word “nail” in common with the input text string. In various embodiments, any one or any combination of the idiomatic expressions returned as search results in operation 612 may be added to a candidate set of idiomatic expressions, which may be utilized by operations in process 500.

In some embodiments, the computing device 100 may store a historical log (e.g., a record) of the searches performed in operation 612. In particular, the historical log may include the input text string used by the search and the idiomatic expressions returned as search results. In some embodiments, the computing device 100 may utilize the historical log to determine one or more commonality metrics that are each based upon a unique data set that includes a particular input text string used by the search in operation 612 and a particular idiomatic expression stored in database 108. A particular commonality metric may be determined by analyzing a set of searches that returned the particular idiomatic expression as a search result over a predetermined period of time, in which the particular commonality metric may be calculated as the percentage of searches in the set that were based off of the particular input text string.

In some embodiments, upon a determination that the particular commonality metric meets or exceeds a predetermined common error threshold, the particular input text string may be saved in database 108 as common error associated with the particular idiomatic expression. For example, as described above with reference to FIG. 3, in some embodiments the particular input text string may be saved as a common error in database field F33 in a database record that is associated with the particular idiomatic expression. Once the particular input text string is saved as a common error in database 108, it may be of value to other operations in processes 500 and 600 (e.g., operation 606 which searches the common errors stored in database 108 to identify a match).

In operation 614, the computing device 100 performs a search, based on the input text string received in operation 502, of the common errors associated with idiomatic expressions stored in database 108, and includes the idiomatic expressions associated with the search results in the candidate set of idiomatic expressions. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 300 described in detail above with reference to FIG. 3. In some embodiments, the database field F33 of database table 300 may store one or more common errors associated with the idiomatic expression associated with a particular database record in database table 300. For example, with respect to database record R32 in database table 300, the common error “for all intensive purposes” (stored in database field F33) is associated with the idiomatic expression “for all intents and purposes” (stored in database field F32). Accordingly, the search may be performed on database field F33 using any suitable process, heuristic, or algorithm known to a person of ordinary skill in the art, such that the search results are determined based on the query terms (from the input text string) and the common errors stored in database field F33. In some embodiments, the search may be performed using any suitable string-matching algorithm, including those employing approximate matching techniques (e.g., fuzzy string searching algorithms). The search results may include common errors that are each associated with a particular database record (i.e., a particular idiomatic expression) stored in database table 300.

It is to be understood that a common error returned as a search result in operation 614 may not match the input text string, in contrast to the search in operation 606 that is similarly performed on the common errors stored in database 108 and which requires a match as discussed above. For example, the input text string “for all recessive purposes” would not be deemed to match the common error “for all intensive purposes” (stored in database record R32 in database 300), and so this common error would not be returned as a search result in operation 606, whereas in some embodiments this common error may be returned as a search result in operation 614 due to both strings containing the same word “purposes.” In various embodiments, any one or any combination of the idiomatic expressions associated with the common errors returned as search results in operation 614 may be added to a candidate set of idiomatic expressions, which may be utilized by operations in process 500.

In operation 616, the computing device 100 performs a search, based on the input text string received in operation 502, of the keywords associated with idiomatic expressions stored in database 108, and includes the idiomatic expressions associated with the search results in the candidate set of idiomatic expressions. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 300 described in detail above with reference to FIG. 3. In some embodiments, the database field F34 of database table 300 may store one or more keywords (e.g., content words) associated with the idiomatic expression associated with a particular database record in database table 300. For example, with respect to database record R33 in database table 300, the idiomatic expression “between a rock and a hard place” (stored in database field F32) contains the content words “rock,” “hard,” and “place,” which are stored as keywords in database field F34. Accordingly, the search may be performed on database field F34 using any suitable process, heuristic, or algorithm known to a person of ordinary skill in the art, such that the search results are determined based on the query terms (from the input text string) and the keywords stored in database field F34. In some embodiments, the search may be performed using any suitable string-matching algorithm, including those employing approximate matching techniques (e.g., fuzzy string searching algorithms).

The search results may include idiomatic expressions that are each associated with a particular database record stored in database table 300. It is to be understood that an idiomatic expression returned as a search result may not match the input text string. In various embodiments, any one or any combination of the idiomatic expressions returned as search results in operation 616 may be added to a candidate set of idiomatic expressions, which may be utilized by operations in process 500.

In operation 618, the computing device 100 performs a search, based on the input text string received in operation 502, of the base words associated with idiomatic expressions stored in database 108, and includes the idiomatic expressions associated with the search results in the candidate set of idiomatic expressions. According to aspects of the disclosure, the search based on the input text string uses one or more query terms, as discussed in greater detail above with reference to FIG. 5 and in particular operation 504. Such query terms may include, but are not limited to, the following examples: (a) the input text string in its entire form; (b) any one or any combination of substrings contained within the input text string; (c) the keywords contained within the input text string or any substring thereof; and/or (d) the base words derived from the input text string or any substring thereof.

In some embodiments, the search of database 108 may be performed on database table 300 described in detail above with reference to FIG. 3. In some embodiments, the database field F35 of database table 300 may store one or more base words associated with the idiomatic expression associated with a particular database record in database table 300. For example, with respect to database record R32 in database table 300, the idiomatic expression “for all intents and purposes” (stored in database field F32) has the associated base words “intent” and “purpose” which are stored in database field F35. Accordingly, the search may be performed on database field F35 using any suitable process, heuristic, or algorithm known to a person of ordinary skill in the art, such that the search results are determined based on the query terms (from the input text string) and the base words stored in database field F35. In some embodiments, the search may be performed using any suitable string-matching algorithm, including those employing approximate matching techniques (e.g., fuzzy string searching algorithms).

The search results may include idiomatic expressions that are each associated with a particular database record stored in database table 300. It is to be understood that an idiomatic expression returned as a search result may not match the input text string. In various embodiments, any one or any combination of the idiomatic expressions returned as search results in operation 618 may be added to a candidate set of idiomatic expressions, which may be utilized by operations in process 500.

With reference to FIG. 7, a diagram is depicted of an embodiment of a user interface for a computing device 100 configured to perform the methods (e.g., processes) disclosed herein, according to aspects of the disclosure. As illustrated, the user interface may include a screen 700. The screen 700 may be outputted on a display 110 of the computing device 100. As illustrated, the screen 700 may include an input area 702.

According to aspects of the disclosure, the input area 702 may include a text input field 704. The text input field 704 may include one or more text strings inputted by a user of the computing device 100 (i.e., one or more “input text strings”). An input text string may be a string comprised of a sequence of characters that may represent, for example, a word, a phrase, a sentence, a paragraph, or any grammatical unit of language. In some embodiments, the text input field 704 may be replaced with any other suitable type of user input component capable of receiving an input text string from a user, whether or not another form of data may be used to derive the input text string (e.g., speech recognition technology that determines the input text string from spoken language stored in an audio format).

As illustrated, the input text field 704 includes an input text string “The coach hit the nail on the head when he said the team's problem is that the players don't have confidence in one another,” in which the phrase “hit the nail on the head” is emphasized by underline. The phrase “hit the nail on the head” is emphasized as a result of the phrase being identified as a correct idiomatic expression (i.e., an “identified correct idiomatic expression”). In some embodiments, the phrase may be emphasized by any suitable means that draws the user's attention to the phrase, including, but not limited to: text color, background color, text font, text bolding, underline, and italics. When the user selects the emphasized phrase, a pop-up window 706 may be launched and opened in response. In various embodiments, the user may select the emphasized phrase by any suitable means including, but not limited to: clicking any part of the emphasized phrase (e.g., using a computer mouse); hovering over any part of the emphasized phrase (e.g., using a computer mouse); and pressing on any part of the emphasized phrase (e.g., pressing on the touchscreen 114 of the computing device 100). In some embodiments, the pop-up window 706 may be replaced with any other suitable type of user interface message or notification. In an alternative embodiment, when the user selects the emphasized phrase, the computing device 100 may hide the screen 700 and display in its place an alternate screen that may include the same elements and/or perform the same functions as the pop-up window 706.

According to aspects of the disclosure, the pop-up window 706 may include, for example, informational elements 708-712 and push buttons 714-718, or any combination thereof. The pop-up window 706 is of a type that is configured for use with an identified correct idiomatic expression, which was identified within the input text string received from input text field 704. As illustrated, the informational element 708 may include a visual representation of the identified correct idiomatic expression (i.e., “hit the nail on the head”). As illustrated, the informational element 710 may include a visual representation of the meaning associated with the identified correct idiomatic expression, the meaning having been received from operation 522 as output and having been obtained from database 108 as a result of a search performed in operation 504. As illustrated, the informational element 712 may include a visual representation of one or more examples of use associated with the identified correct idiomatic expression, the examples of use having been received from operation 522 as output and having been obtained from database 108 as a result of a search performed in operation 504.

As illustrated, the pop-up window 706 may include push buttons 714-718. According to aspects of the disclosure, the user may press the push button 714 to request to view “Alternatives with Similar Meaning” (as illustrated on the face of push button 714), with such alternatives being definitionally similar idiomatic expressions (i.e., idiomatic expressions determined to have generally similar meanings to the identified correct idiomatic expression). When push button 714 is pressed, a pop-up window 720 (described below) may be launched and opened in response. In some embodiments, the pop-up window 720 may be replaced with any other suitable type of user interface message or notification. In an alternative embodiment, when push button 714 is pressed, the computing device 100 may hide the screen 700 and display in its place an alternate screen that may include the same elements and/or perform the same functions as the pop-up window 720. In some embodiments, the push button 714 may be replaced with any other suitable type of user input component.

According to aspects of the disclosure, the user may press the push button 716 to request to view “Alternatives with Similar Wording” (as illustrated on the face of push button 716), with such alternatives being idiomatic expressions containing similar wording (i.e., idiomatic expressions determined to contain similar words to the identified correct idiomatic expression). When push button 716 is pressed, a pop-up window 728 (described below) may be launched and opened in response. In some embodiments, the pop-up window 728 may be replaced with any other suitable type of user interface message or notification. In an alternative embodiment, when push button 716 is pressed, the computing device 100 may hide the screen 700 and display in its place an alternate screen that may include the same elements and/or perform the same functions as the pop-up window 728. In some embodiments, the push button 716 may be replaced with any other suitable type of user input component.

According to aspects of the disclosure, the user may press the push button 718 to request to view “Alternatives with Opposed Meaning” (as illustrated on the face of push button 718), with such alternatives being definitionally opposed idiomatic expressions (i.e., idiomatic expressions determined to have generally opposing meanings to the identified correct idiomatic expression). When push button 718 is pressed, a pop-up window 736 (described below) may be launched and opened in response. In some embodiments, the pop-up window 736 may be replaced with any other suitable type of user interface message or notification. In an alternative embodiment, when push button 718 is pressed, the computing device 100 may hide the screen 700 and display in its place an alternate screen that may include the same elements and/or perform the same functions as the pop-up window 736. In some embodiments, the push button 718 may be replaced with any other suitable type of user input component.

According to aspects of the disclosure, the pop-up window 720 may include, for example, a set of informational elements 722 (collectively) and push buttons 724-726, or any combination thereof. The pop-up window 720 is of a type that is configured for use with a related idiomatic expression, such as a definitionally similar idiomatic expression that has been determined to have a generally similar meaning to the identified correct idiomatic expression. As illustrated, the set of informational elements 722 (collectively) may include: (a) a visual representation of a first definitionally similar idiomatic expression, the first definitionally similar idiomatic expression having been received from operation 522 as output and having been obtained from database 108 as a result of a search performed in operation 516; (b) a visual representation of the meaning associated with the first definitionally similar idiomatic expression, the meaning having been received from operation 522 as output and having been obtained from database 108 as a result of a search performed in operation 516; and/or (c) a visual representation of one or more examples of use associated with the first definitionally similar idiomatic expression, the examples of use having been received from operation 522 as output and having been obtained from database 108 as a result of a search performed in operation 516.

As illustrated, the pop-up window 720 may include push buttons 724-726. According to aspects of the disclosure, the user may press the push button 724 to request that the definitionally similar idiomatic expression that is visually represented in pop-up window 720 be used to replace the identified correct idiomatic expression in the input text string. When push button 724 is pressed, the text input field 704 may be updated in response, such that the input text string included in the input text field 704 may be updated by replacing the identified correct idiomatic expression in the input text string with the definitionally similar idiomatic expression in the exact same location within the input text string. In some embodiments, the push button 724 may be replaced with any other suitable type of user input component. According to aspects of the disclosure, the user may press the push button 726 to request a next definitionally similar idiomatic expression (e.g., a second definitionally similar idiomatic expression) out of a set of definitionally similar idiomatic expressions stored in database 108 wherein each has been determined to have a generally similar meaning to the identified correct idiomatic expression. When push button 726 is pressed, the pop-up window 720 may be updated in response, such that the set of informational elements 722 (collectively) and their respective visual representations may be updated to reflect data associated with the next definitionally similar idiomatic expression being requested. In some embodiments, the push button 726 may be replaced with any other suitable type of user input component.

According to aspects of the disclosure, the pop-up window 728 may include, for example, a set of informational elements 730 (the set collectively) and push buttons 732-734, or any combination thereof. The pop-up window 728 is of a type that is configured for use with a related idiomatic expression, such as an idiomatic expression containing similar wording that has been determined to contain similar words to the identified correct idiomatic expression. As illustrated, the set of informational elements 730 (collectively) may include: (a) a visual representation of a first idiomatic expression containing similar wording, the first idiomatic expression containing similar wording having been received from operation 522 as output and having been obtained from database 108 as a result of a search performed in operation 520; (b) a visual representation of the meaning associated with the first idiomatic expression containing similar wording, the meaning having been received from operation 522 as output and having been obtained from database 108 as a result of a search performed in operation 520; and/or (c) a visual representation of one or more examples of use associated with the first idiomatic expression containing similar wording, the examples of use having been received from operation 522 as output and having been obtained from database 108 as a result of a search performed in operation 520.

As illustrated, the pop-up window 728 may include push buttons 732-734. According to aspects of the disclosure, the user may press the push button 732 to request that the idiomatic expression containing similar wording that is visually represented in pop-up window 728 be used to replace the identified correct idiomatic expression in the input text string. When push button 732 is pressed, the text input field 704 may be updated in response, such that the input text string included in the input text field 704 may be updated by replacing the identified correct idiomatic expression in the input text string with the idiomatic expression containing similar wording in the exact same location within the input text string. In some embodiments, the push button 732 may be replaced with any other suitable type of user input component. According to aspects of the disclosure, the user may press the push button 734 to request a next idiomatic expression containing similar wording (e.g., a second idiomatic expression containing similar wording) out of a set of idiomatic expressions containing similar wording stored in database 108 wherein each has been determined to contain similar words to the identified correct idiomatic expression. When push button 734 is pressed, the pop-up window 728 may be updated in response, such that the set of informational elements 730 (collectively) and their respective visual representations may be updated to reflect data associated with the next idiomatic expression containing similar wording being requested. In some embodiments, the push button 734 may be replaced with any other suitable type of user input component.

According to aspects of the disclosure, the pop-up window 736 may include, for example, a set of informational elements 738 (the set collectively) and push buttons 740-742, or any combination thereof. The pop-up window 736 is of a type that is configured for use with a related idiomatic expression, such as a definitionally opposed idiomatic expression that has been determined to have a generally opposing meaning to the identified correct idiomatic expression. As illustrated, the set of informational elements 738 (collectively) may include: (a) a visual representation of a first definitionally opposed idiomatic expression, the first definitionally opposed idiomatic expression having been received from operation 522 as output and having been obtained from database 108 as a result of a search performed in operation 518; (b) a visual representation of the meaning associated with the first definitionally opposed idiomatic expression, the meaning having been received from operation 522 as output and having been obtained from database 108 as a result of a search performed in operation 518; and/or (c) a visual representation of one or more examples of use associated with the first definitionally opposed idiomatic expression, the examples of use having been received from operation 522 as output and having been obtained from database 108 as a result of a search performed in operation 518.

As illustrated, the pop-up window 736 may include push buttons 740-742. According to aspects of the disclosure, the user may press the push button 740 to request that the definitionally opposed idiomatic expression that is visually represented in pop-up window 736 be used to replace the identified correct idiomatic expression in the input text string. When push button 740 is pressed, the text input field 704 may be updated in response, such that the input text string included in the input text field 704 may be updated by replacing the identified correct idiomatic expression in the input text string with the definitionally opposed idiomatic expression in the exact same location within the input text string. In some embodiments, the push button 740 may be replaced with any other suitable type of user input component. According to aspects of the disclosure, the user may press the push button 742 to request a next definitionally opposed idiomatic expression (e.g., a second definitionally opposed idiomatic expression) out of a set of definitionally opposed idiomatic expressions stored in database 108 wherein each has been determined to have a generally opposing meaning to the identified correct idiomatic expression. When push button 742 is pressed, the pop-up window 736 may be updated in response, such that the set of informational elements 738 (collectively) and their respective visual representations may be updated to reflect data associated with the next definitionally opposed idiomatic expression being requested. In some embodiments, the push button 742 may be replaced with any other suitable type of user input component.

With reference to FIG. 8, a diagram is depicted of an embodiment of a user interface for a computing device 100 configured to perform the methods and/or processes disclosed herein, according to aspects of the disclosure. As illustrated, the user interface may include a screen 800. The screen 800 may be outputted on a display 110 of the computing device 100. As illustrated, the screen 800 may include an input area 802.

According to aspects of the disclosure, the input area 802 may include a text input field 804. The text input field 804 may include one or more text strings inputted by a user of the computing device 100 (i.e., one or more “input text strings”). An input text string may be a string comprised of a sequence of characters that may represent, for example, a word, a phrase, a sentence, a paragraph, or any grammatical unit of language. In some embodiments, the text input field 804 may be replaced with any other suitable type of user input component capable of receiving an input text string from a user, whether or not another form of data may be used to derive the input text string (e.g., speech recognition technology that determines the input text string from spoken language stored in an audio format).

As illustrated, the input text field 804 includes an input text string “For all intensive purposes, my opinion nearly always mirrors that of my brother when it comes to choosing a restaurant,” in which the phrase “For all intensive purposes” is emphasized by underline. The phrase “For all intensive purposes” is emphasized as a result of the phrase being identified as an incorrect idiomatic expression (i.e., an “identified incorrect idiomatic expression”). In some embodiments, the phrase may be emphasized by any suitable means that draws the user's attention to the phrase, including, but not limited to: text color, background color, text font, text bolding, underline, and italics. When the user selects the emphasized phrase, a pop-up window 806 may be launched and opened in response. In various embodiments, the user may select the emphasized phrase by any suitable means including, but not limited to: clicking any part of the emphasized phrase (e.g., using a computer mouse); hovering over any part of the emphasized phrase (e.g., using a computer mouse); and pressing on any part of the emphasized phrase (e.g., pressing on the touchscreen 114 of the computing device 100). In some embodiments, the pop-up window 806 may be replaced with any other suitable type of user interface message or notification. In an alternative embodiment, when the user selects the emphasized phrase, the computing device 100 may hide the screen 800 and display in its place an alternate screen that may include the same elements and/or perform the same functions as the pop-up window 806.

According to aspects of the disclosure, the pop-up window 806 may include, for example, informational elements 808-812 and push buttons 814-822, or any combination thereof. The pop-up window 806 is of a type that is configured for use with a suggested correct idiomatic expression that has been determined by the validation process disclosed herein to be a correct idiomatic expression that may have been intended to be used instead of an identified incorrect idiomatic expression (within the input text string). As illustrated, the informational element 808 may include a visual representation of the suggested correct idiomatic expression (i.e., “for all intents and purposes”). The suggested correct idiomatic expression was received from operation 522 as output and was obtained from database 108 as a result of a search performed in operation 504. As illustrated, the informational element 810 may include a visual representation of the meaning associated with the suggested correct idiomatic expression, the meaning having been received from operation 522 as output and having been obtained from database 108 as a result of a search performed in operation 504. As illustrated, the informational element 812 may include a visual representation of one or more examples of use associated with the suggested correct idiomatic expression, the examples of use having been received from operation 522 as output and having been obtained from database 108 as a result of a search performed in operation 504.

According to aspects of the disclosure, the user may press the push button 814 to request that the suggested correct idiomatic expression that is visually represented in pop-up window 806 be used to replace the identified incorrect idiomatic expression in the input text string. When push button 814 is pressed, the text input field 804 may be updated in response, such that the input text string included in the input text field 804 may be updated by replacing the identified incorrect idiomatic expression (i.e., “For all intensive purposes”) with the suggested correct idiomatic expression (i.e., “for all intents and purposes”) in the exact same location within the input text string. In some embodiments, the push button 814 may be replaced with any other suitable type of user input component.

According to aspects of the disclosure, the user may press the push button 816 to request a next suggested correct idiomatic expression (e.g., a second suggested correct idiomatic expression) out of a set of suggested correct idiomatic expression stored in database 108 wherein each has been determined by the validation process disclosed herein to be a correct idiomatic expression that may have been intended to be used instead of the identified incorrect idiomatic expression. When push button 816 is pressed, the pop-up window 806 may be updated in response, such that informational elements 808-812 and their respective visual representations may be updated to reflect data associated with the next suggested correct idiomatic expression being requested. In some embodiments, the push button 816 may be replaced with any other suitable type of user input component.

According to aspects of the disclosure, the user may press the push button 818 to request to view “Alternatives with Similar Meaning” (as illustrated on the face of push button 818), with such alternatives being definitionally similar idiomatic expressions (i.e., idiomatic expressions determined to have generally similar meanings to the suggested correct idiomatic expression). In some embodiments, the push button 818 may be replaced with any other suitable type of user input component. When push button 818 is pressed, a pop-up window (not illustrated) may be launched and opened in response. The pop-up window launched by pressing push button 818 is substantially similar to the pop-up window 720 with reference to FIG. 7, and these pop-up windows are used in a substantially similar manner, except that pop-up window 720 is used for definitionally similar idiomatic expressions associated with the identified correct idiomatic expression whereas the pop-up window launched by pressing push button 818 is used for definitionally similar idiomatic expressions associated with the suggested correct idiomatic expression. In some embodiments, the pop-up window launched by pressing push button 818 may be replaced with any other suitable type of user interface message or notification. In an alternative embodiment, when push button 818 is pressed, the computing device 100 may hide the screen 800 and display in its place an alternate screen that may include the same elements and/or perform the same functions as the pop-up window launched by pressing push button 818.

According to aspects of the disclosure, the user may press the push button 820 to request to view “Alternatives with Similar Wording” (as illustrated on the face of push button 820), with such alternatives being idiomatic expressions containing similar wording (i.e., idiomatic expressions determined to contain similar words to the suggested correct idiomatic expression). In some embodiments, the push button 820 may be replaced with any other suitable type of user input component. In some embodiments, the push button 820 may be replaced with any other suitable type of user input component. When push button 820 is pressed, a pop-up window (not illustrated) may be launched and opened in response. The pop-up window launched by pressing push button 820 is substantially similar to the pop-up window 728 with reference to FIG. 7, and these pop-up windows are used in a substantially similar manner, except that pop-up window 728 is used for idiomatic expression containing similar wording to the identified correct idiomatic expression whereas the pop-up window launched by pressing push button 818 is used for idiomatic expression containing similar wording to the suggested correct idiomatic expression. In some embodiments, the pop-up window launched by pressing push button 820 may be replaced with any other suitable type of user interface message or notification. In an alternative embodiment, when push button 820 is pressed, the computing device 100 may hide the screen 800 and display in its place an alternate screen that may include the same elements and/or perform the same functions as the pop-up window launched by pressing push button 820.

According to aspects of the disclosure, the user may press the push button 822 to request to view “Alternatives with Opposed Meaning” (as illustrated on the face of push button 822), with such alternatives being definitionally opposed idiomatic expressions (i.e., idiomatic expressions determined to have generally opposing meanings to the suggested correct idiomatic expression). In some embodiments, the push button 822 may be replaced with any other suitable type of user input component. When push button 822 is pressed, a pop-up window (not illustrated) may be launched and opened in response. The pop-up window launched by pressing push button 822 is substantially similar to the pop-up window 736 with reference to FIG. 7, and these pop-up windows are used in a substantially similar manner, except that pop-up window 736 is used for definitionally opposed idiomatic expressions associated with the identified correct idiomatic expression whereas the pop-up window launched by pressing push button 822 is used for definitionally opposed idiomatic expressions associated with the suggested correct idiomatic expression. In some embodiments, the pop-up window launched by pressing push button 822 may be replaced with any other suitable type of user interface message or notification. In an alternative embodiment, when push button 822 is pressed, the computing device 100 may hide the screen 800 and display in its place an alternate screen that may include the same elements and/or perform the same functions as the pop-up window launched by pressing push button 822.

According to various embodiments of the present disclosure, at least a part of the systems, methods, and computer-readable medium for validation of idiomatic expressions disclosed herein may be implemented with software, firmware, hardware, or any combination thereof. At least a part of the systems, methods, and computer-readable medium for validation of idiomatic expressions disclosed herein may be implemented (e.g., executed) by a processor (e.g., the processor 102). At least a part of the systems, methods, and computer-readable medium for validation of idiomatic expressions disclosed herein may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit,” “logic,” “logical block,” “component,” and “circuit.” The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions of the devices) or methods (e.g., operations) according to various embodiments of the present disclosure may be implemented as instructions stored in a computer-readable storage medium in the form of a module. In the case where the instructions are performed by a processor, the processor may perform functions corresponding to the instructions. The computer-readable storage medium may be, for example, the memory 104.

A computer-readable storage medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The instructions may include machine language codes generated by compilers and high-level language codes that can be executed by computers using interpreters. For example, an electronic device may include a processor and a memory for storing computer-readable instructions. The memory may include instructions for performing the above-mentioned various methods or functions when executed by the processor. The above-mentioned hardware (e.g., devices) may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module, or other elements according to various embodiments of the present disclosure may be performed in a sequential, parallel, iterative, or heuristic way. Furthermore, some operations may be performed in another order or may be omitted, or other operations may be added.

While the present disclosure may have been shown and described with reference to various embodiments thereof, it will be understood by those skilled in the art that various changes in form and details may be made therein without departing from the spirit and scope of the present disclosure as defined by the appended claims and their equivalents. In other words, the present disclosure is not limited to the various exemplary embodiments disclosed herein, but rather these embodiments are intended to serve as illustrative examples to facilitate a more easy and complete understanding of the present disclosure.

What is claimed is:

1. A computing device configured to perform validation of idiomatic expressions, the computing device comprising:
one or more processors; and
a memory storing computer-readable instructions that, when executed by the one or more processors, cause the computing device to:
receive an input text string;
perform a search of a database based on the input text string, the database storing a plurality of idiomatic expressions;
identify a first set of idiomatic expressions, the first set including at least one of the plurality of idiomatic expressions stored in the database, each idiomatic expression in the first set having an associated concordance score that meets or exceeds a predetermined concordance threshold value, the associated concordance score indicating a degree of similarity between the respective idiomatic expression in the first set and the input text string; and
output the first set of idiomatic expressions.

2. The computing device of claim 1, wherein:
the associated concordance score is determined based on a comparison between the respective idiomatic expression in the first set and the input text string, the comparison being performed utilizing a string distance function.

3. The computing device of claim 1, wherein:
the associated concordance score is determined based on a comparison between the respective idiomatic expression in the first set and the input text string, the comparison being performed utilizing an n-gram based technique.

4. The computing device of claim 1, wherein the database stores a plurality of records, each record including a different one of the plurality of idiomatic expressions and a common error associated with the idiomatic expression included in the record, the plurality of records including a first record, the first record including a first idiomatic expression and a first common error associated with the first idiomatic expression, wherein the computer-readable instructions when executed by the one or more processors, further cause the computing device to:
assign a value for the concordance score associated with the first idiomatic expression that meets or exceeds the predetermined concordance threshold value, in response to detecting that the first common error associated with the first idiomatic expression matches the input text string.

5. The computing device of claim 1, wherein the database stores a plurality of records, each record including a different one of the plurality of idiomatic expressions and an associated explanatory description of the idiomatic expression included in the record, wherein the computer-readable instructions when executed by the one or more processors, further cause the computing device to:
output the explanatory description associated with each idiomatic expression included in the first set.

6. The computing device of claim 5, wherein:
the explanatory description associated with each idiomatic expression includes at least one of a meaning and an example of use.

7. The computing device of claim 1, wherein the database stores a plurality of records, each record including a different one of the plurality of idiomatic expressions and a set of pointers associated with the idiomatic expression included in the record, the plurality of records including a first record, the first record including a first idiomatic expression and a first set of pointers associated with the first idiomatic expression, the first set of pointers including at least a first pointer, the first pointer referencing a second record, the second record including a second idiomatic expression that is definitionally similar to the first idiomatic expression, wherein the computer-readable instructions when executed by the one or more processors, further cause the computing device to:
insert the second idiomatic expression into the first set in response to detecting that the first idiomatic expression is included in the first set.

8. The computing device of claim 1, wherein the database stores a plurality of records, each record including a different one of the plurality of idiomatic expressions and a set of pointers associated with the idiomatic expression included in the record, the plurality of records including a first record, the first record including a first idiomatic expression and a first set of pointers associated with the first idiomatic expression, the first set of pointers including at least a first pointer, the first pointer referencing a second record, the second record including a second idiomatic expression that is definitionally opposed to the first idiomatic expression, wherein the computer-readable instructions when executed by the one or more processors, further cause the computing device to:
insert the second idiomatic expression into the first set in response to detecting that the first idiomatic expression is included in the first set.

9. The computing device of claim 1, wherein the computer-readable instructions when executed by the one or more processors, further cause the computing device to:
identify one or more content words contained within the input text string; and
determine a base form of each content word,
wherein the search of the database based on the input text string includes searching for the base forms of the one or more content words.

10. The computing device of claim 1, wherein:
the database stores a plurality of records, each record including a different one of the plurality of idiomatic expressions and a set of base words associated with the idiomatic expression included in the respective record, the plurality of records including a first record, the first record including a first idiomatic expression and a first set of base words, the first set of base words including a base form of each of the one or more content words contained within the first idiomatic expression; and
the concordance score associated with the first idiomatic expression is determined based on a comparison between the first set of base words and the input text string.

11. The computing device of claim 1, wherein the computer-readable instructions when executed by the one or more processors, further cause the computing device to:
identify one or more substrings contained within the input text string,
wherein the search of the database based on the input text string includes searching the database based on at least one of the substrings.

12. The computing device of claim 1, wherein the computer-readable instructions when executed by the one or more processors, further cause the computing device to:
identify one or more substrings contained within the input text string in response to detecting that no idiomatic expression in the first set has an associated concordance score that meets or exceeds a predetermined refinement threshold value, the predetermined refinement threshold value being greater than or equal to the predetermined concordance threshold value;
perform a search of the database based on one of the substrings to identify a second set of idiomatic expressions after identifying one or more substrings contained within the input text string, the second set including at least one of the plurality of idiomatic expressions stored in the database; and
output the second set of idiomatic expressions.

13. A method for validation of idiomatic expressions, comprising the steps of:
receiving an input text string;
performing a search of a database based on the input text string, the database storing a plurality of idiomatic expressions;
identifying a first set of idiomatic expressions, the first set including at least one of the plurality of idiomatic expressions stored in the database, each idiomatic expression in the first set having an associated concordance score that meets or exceeds a predetermined concordance threshold value, the associated concordance score indicating a degree of similarity between the respective idiomatic expression in the first set and the input text string; and
outputting the first set of idiomatic expressions.

14. The method of claim 13, wherein:
the associated concordance score is determined based on a comparison between the respective idiomatic expression in the first set and the input text string, the comparison being performed utilizing a string distance function.

15. The method of claim 13, wherein:
the associated concordance score is determined based on a comparison between the respective idiomatic expression in the first set and the input text string, the comparison being performed utilizing n-gram analysis.

16. The method of claim 13, wherein the database stores a plurality of records, each record including a different one of the plurality of idiomatic expressions and a common error associated with the idiomatic expression included in the record, the plurality of records including a first record, the first record including a first idiomatic expression and a first common error associated with the first idiomatic expression, the method further comprising:
assigning a value for the concordance score associated with the first idiomatic expression that meets or exceeds the predetermined concordance threshold value, in response to detecting that the first common error associated with the first idiomatic expression matches the input text string.

17. The method of claim 16, wherein the database stores a plurality of records, each record including a different one of the plurality of idiomatic expressions and an associated explanatory description of the idiomatic expression included in the record, the method further comprising:
outputting the explanatory description associated with each idiomatic expression included in the first set.

18. The method of claim 17, wherein:
the explanatory description associated with each idiomatic expression includes at least one of a meaning and an example of use.

19. The method of claim 13, wherein the database stores a plurality of records, each record including a different one of the plurality of idiomatic expressions and a set of pointers associated with the idiomatic expression included in the record, the plurality of records including a first record, the first record including a first idiomatic expression and a first set of pointers associated with the first idiomatic expression, the first set of pointers including at least a first pointer, the first pointer referencing a second record, the second record including a second idiomatic expression that is definitionally similar to the first idiomatic expression, the method further comprising:
inserting the second idiomatic expression into the first set in response to detecting that the first idiomatic expression is included in the first set.

20. The method of claim 13, wherein the database stores a plurality of records, each record including a different one of the plurality of idiomatic expressions and a set of pointers associated with the idiomatic expression included in the record, the plurality of records including a first record, the first record including a first idiomatic expression and a first set of pointers associated with the first idiomatic expression, the first set of pointers including at least a first pointer, the first pointer referencing a second record, the second record including a second idiomatic expression that is definitionally opposed to the first idiomatic expression, the method further comprising:
inserting the second idiomatic expression into the first set in response to detecting that the first idiomatic expression is included in the first set.

21. The method of claim 13, further comprising:
identifying one or more content words contained within the input text string; and
determining a base form of each content word,
wherein the step of performing the search of the database based on the input text string includes searching for the base forms of the one or more content words.

22. The method of claim 13, wherein:
the database stores a plurality of records, each record including a different one of the plurality of idiomatic expressions and a set of base words associated with the idiomatic expression included in the respective record, the plurality of records including a first record, the first record including a first idiomatic expression and a first set of base words, the first set of base words including a base form of each of the one or more content words contained within the first idiomatic expression; and
the concordance score associated with the first idiomatic expression is determined based on a comparison between the first set of base words and the input text string.

23. The method of claim 13, further comprising:
identifying one or more substrings contained within the input text string,
wherein the step of performing the search of the database based on the input text string includes searching the database based on at least one of the substrings.

24. The method of claim 13, further comprising:
identifying one or more substrings contained within the input text string in response to detecting that no idiomatic expression in the first set has an associated concordance score that meets or exceeds a predetermined refinement threshold value, the predetermined refinement threshold value being greater than or equal to the predetermined concordance threshold value;
performing a search of the database based on one of the substrings to identify a second set of idiomatic expressions after identifying one or more substrings contained within the input text string, the second set including at least one of the plurality of idiomatic expressions stored in the database; and
outputting the second set of idiomatic expressions.

25. A non-transitory computer-readable medium configured to store instructions that when executed cause a processor to perform validation of idiomatic expressions, the processor being further configured to:
receive an input text string;
perform a search of a database based on the input text string, the database storing a plurality of idiomatic expressions;
identify a first set of idiomatic expressions, the first set including at least one of the plurality of idiomatic expressions stored in the database, each idiomatic expression in the first set having an associated concordance score that meets or exceeds a predetermined concordance threshold value, the associated concordance score indicating a degree of similarity between the respective idiomatic expression in the first set and the input text string; and
output the first set of idiomatic expressions.
